(19) United States
(12) Patent Application Publication
(10) Pub. No.: US 2025/0274374 A1
(43) Pub. Date: Aug. 28, 2025

(54) TEST INFORMATION MANAGEMENT SYSTEM, TEST INFORMATION MANAGEMENT APPARATUS, INFORMATION CONVERSION APPARATUS, AND TEST INFORMATION MANAGEMENT METHOD

(71) Applicant: Mitsubishi Electric Corporation, Chiyoda-ku, Tokyo (JP)

(72) Inventors: Ryoichi WATANABE, Tokyo (JP); Yuji HAMADA, Tokyo (JP)

(73) Assignee: Mitsubishi Electric Corporation, Chiyoda-ku, Tokyo (JP)

(21) Appl. No.: 18/857,518

(22) PCT Filed: May 26, 2022
(86) PCT No.: PCT/JP2022/021647

§ 371 Date: Oct. 17, 2024

(51) Int. Cl. H04L 43/50; H04L 43/0852; H04L 43/16; H04W 84/00

(52) U.S. Cl. CPC H04L 43/50; H04L 43/0852; H04L 43/16; H04W 84/005

(57) ABSTRACT

A test information management system includes: a train information processing apparatus that transmits and receives, in a first intra-train network, data to and from a vehicle device in a second intra-train network and manages an operation of the vehicle device; and a test information management apparatus that includes a device model execution unit capable of executing processing identical to processing executed by the train information processing apparatus and the vehicle device, and performs control to distribute data transmitted from a transmission source of the data or data obtained by the device model execution unit to a transmission destination of the data, based on a communication state between the train information processing apparatus and the vehicle device.

### FIELD

The present disclosure relates to a test information management system for performing a test on a device, to a test information management apparatus, to an information conversion apparatus, and to a test information management method.

### BACKGROUND

Situations such as restrictions on overseas business trips due to the coronavirus pandemic, and the purpose of achieving efficient combination tests result in an increasing need for remotely performing a combination test with actual machines using a plurality of devices to be used in railroad vehicles in domestic and overseas manufacturers. Additionally, the Shift2Rail project, which is a European research project on railroads, also mentions the necessity of a remote combination test with actual machines for devices to be used in railroad vehicles, and it is necessary to take actions. Regarding the combination test with actual machines, for example, Patent Literature 1 discloses a technique capable of reducing an influence of a delay in acquiring data by switching and using processing results in accordance with results from a server processing time estimation unit.

### CITATION LIST

### Patent Literature

Patent Literature 1: Japanese Patent No. 5949506

### SUMMARY OF INVENTION

### Problem to be Solved by the Invention

However, the above-described conventional technique involves a problem that, in a case where target devices that transmit and receive data to and from each other are present in different networks, when the target devices undergo a delay in communication between the networks, real-time properties are impaired between the target devices that transmit and receive data to and from each other.

The present disclosure has been made in view of the circumstances, and an object of the present disclosure is to provide a test information management system capable of reducing an influence of a communication delay and continuously performing a combination test even when devices to be subjected to the combination test are present in different networks and undergo the communication delay.

### Means to Solve the Problem

To solve the above problem and achieve the object, a test information management system of the present disclosure comprises: a train information processing apparatus to transmit and receive, in a first intra-train network, data to and from a vehicle device in a second intra-train network and to manage an operation of the vehicle device, and a test information management apparatus including a device model execution unit capable of executing processing identical to processing executed by the train information processing apparatus and the vehicle device, and to perform control to distribute data transmitted from a transmission source of the data or data obtained by the device model execution unit to a transmission destination of the data, on a basis of a communication state between the train information processing apparatus and the vehicle device.

### Effects of the Invention

The test information management system of the present disclosure has an effect of being able to reduce the influence of the communication delay and continuously perform the combination test even when the devices to be subjected to the combination test are present in different networks and undergo the communication delay.

### BRIEF DESCRIPTION OF DRAWINGS

FIG. 1 is a diagram illustrating an exemplary configuration of a test information management system according to a first embodiment.

FIG. 2 is a diagram illustrating an exemplary configuration of a train control system installed on a typical train.

FIG. 3 is a first diagram illustrating an example of a typical combination test with actual machines.

FIG. 4 is a second diagram illustrating an example of a typical combination test with actual machines.

FIG. 5 is a flowchart illustrating operations of the test information management system according to the first embodiment.

FIG. 6 is a diagram illustrating an exemplary configuration of a test information management apparatus according to the first embodiment.

FIG. 7 is a diagram illustrating an exemplary configuration of an information conversion apparatus according to the first embodiment.

FIG. 8 is a diagram illustrating an exemplary configuration of a train information processing apparatus according to the first embodiment.

FIG. 9 is a flowchart illustrating operations of a vehicle device according to the first embodiment.

FIG. 10 is a flowchart illustrating operations of the information conversion apparatus according to the first embodiment.

FIG. 11 is a diagram illustrating an example of data communication protocol conversion performed by the information conversion apparatus according to the first embodiment.

FIG. 12 is a flowchart illustrating operations of the train information processing apparatus according to the first embodiment.

FIG. 13 is a first flowchart illustrating operations of the test information management apparatus according to the first embodiment.

FIG. 14 is a second flowchart illustrating the operations of the test information management apparatus according to the first embodiment.

FIG. 15 is a first diagram illustrating a concept in which the test information management apparatus according to the first embodiment distributes data obtained as a result of a device model execution unit executing a device model.

FIG. 16 is a second diagram illustrating the concept in which the test information management apparatus according to the first embodiment distributes the data obtained as the result of the device model execution unit executing the device model.

FIG. 17 is a diagram illustrating an example of a configuration of processing circuitry in a case where a processor and a memory implement the processing circuitry of the test information management apparatus according to the first embodiment.

FIG. 18 is a diagram illustrating an example of a configuration of processing circuitry in a case where dedicated hardware implements the processing circuitry of the test information management apparatus according to the first embodiment.

FIG. 19 is a diagram illustrating an exemplary configuration of an information conversion apparatus according to a second embodiment.

FIG. 20 is a flowchart illustrating operations of the information conversion apparatus according to the second embodiment.

FIG. 21 is a diagram illustrating a concept in which a difference data is extracted from data received by the information conversion apparatus and only the difference data is transmitted and received in a test information management system according to the second embodiment.

FIG. 22 is a diagram illustrating an exemplary configuration of an information conversion apparatus according to a third embodiment.

FIG. 23 is a flowchart illustrating operations of the information conversion apparatus according to the third embodiment.

FIG. 24 is a diagram illustrating an example in which the information conversion apparatus according to the third embodiment selects data from among pieces of data received from the test information management apparatuses.

FIG. 25 is a diagram illustrating an exemplary configuration of a test information management system according to a fourth embodiment.

FIG. 26 is a diagram illustrating an exemplary configuration of a test information management apparatus according to a fifth embodiment.

FIG. 27 is a diagram illustrating an exemplary configuration of a test information management system according to a sixth embodiment.

### DESCRIPTION OF EMBODIMENTS

Hereinafter, with reference to the drawings, a description will be given in detail of a test information management system, a test information management apparatus, an information conversion apparatus, and a test information management method according to embodiments of the present disclosure.

### First Embodiment

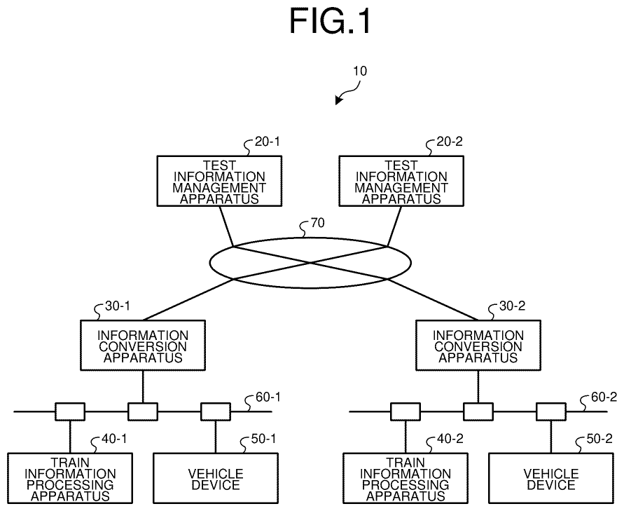

FIG. 1 is a diagram illustrating an exemplary configuration of a test information management system 10 according to a first embodiment. The test information management system 10 includes test information management apparatuses 20-1 and 20-2, information conversion apparatuses 30-1 and 30-2, train information processing apparatuses 40-1 and 40-2, and vehicle devices 50-1 and 50-2. The test information management system 10 is a system for remotely performing a combination test with actual machines, such as the train information processing apparatuses 40-1 and 40-2, the vehicle devices 50-1 and 50-2, and the like, to be installed on a train which is not illustrated. In the following description, the test information management apparatuses 20-1 and 20-2 may be referred to as test information management apparatuses 20 when not distinguished from each other, the information conversion apparatuses 30-1 and 30-2 may be referred to as information conversion apparatuses 30 when not distinguished from each other, the train information processing apparatuses 40-1 and 40-2 may be referred to as train information processing apparatuses 40 when not distinguished from each other, and the vehicle devices 50-1 and 50-2 may be referred to as vehicle devices 50 when not distinguished from each other.

In the test information management system 10, the information conversion apparatus 30-1, the train information processing apparatus 40-1, and the vehicle device 50-1 are connected to an intra-train network 60-1. In the following description, the information conversion apparatus 30-1, the train information processing apparatus 40-1, and the vehicle device 50-1 connected to the intra-train network 60-1 may be collectively referred to as the intra-train network 60-1. The information conversion apparatus 30-2, the train information processing apparatus 40-2, and the vehicle device 50-2 are connected to an intra-train network 60-2. In the following description, the information conversion apparatus 30-2, the train information processing apparatus 40-2, and the vehicle device 50-2 connected to the intra-train network 60-2 may be collectively referred to as the intra-train network 60-2. The intra-train networks 60-1 and 60-2 are networks simulating intra-train networks to be used in an actual train.

In the following description, the intra-train networks 60-1 and 60-2 may be referred to as intra-train networks 60 when not distinguished from each other. Additionally, one of the intra-train networks 60-1 and 60-2 may be referred to as a first intra-train network, and the other may be referred to as a second intra-train network. Additionally, the information conversion apparatus 30 included in the first intra-train network may be referred to as a first information conversion apparatus, and the information conversion apparatus 30 included in the second intra-train network may be referred to as a second information conversion apparatus.

The intra-train networks 60 are connected to an extra-train network 70 different from the intra-train networks 60. The test information management apparatuses 20 are disposed in the extra-train network 70. The test information management apparatuses 20 may be in the form of a server or a cloud. The extra-train network 70 is, for example, the Internet, but this is a mon-limiting example. In the test information management system 10, the train information processing apparatuses 40 and the vehicle devices 50, which are in the intra-train networks 60 different from each other, transmit and receive data to and from each other via the test information management apparatuses 20.

In FIG. 1, the test information management apparatuses 20, the train information processing apparatuses 40, and the vehicle devices 50, which are included in the test information management system 10, are each two in number, but this number is a non-limiting example. The number may be one or three or more. Additionally, the intra-train networks 60 may be three or more in number, to which the train information processing apparatuses 40, the vehicle devices 50, and the like to be subjected to the combination test by the test information management system 10 are connected. The test information management system 10 includes one or more information conversion apparatuses 30 for each intra-train network 60.

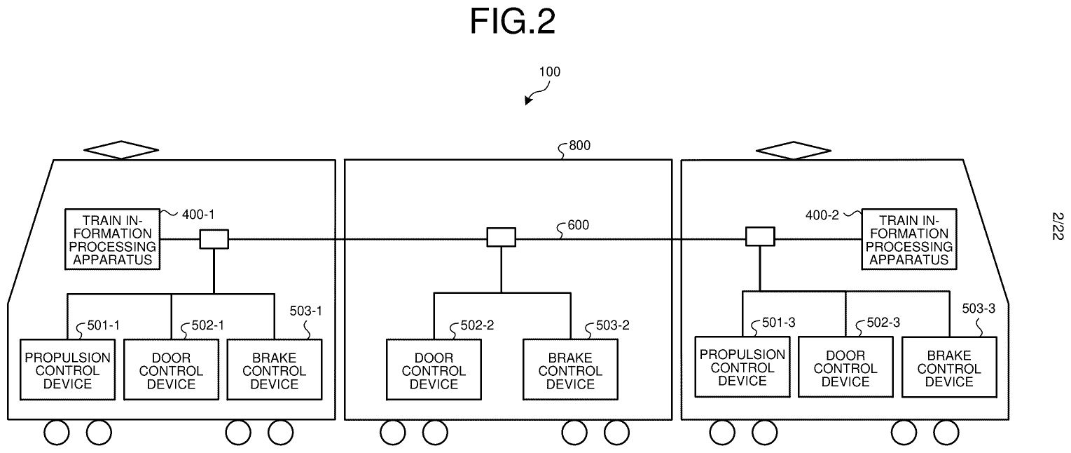

Here, a system installed on an actual train will be described. FIG. 2 is a diagram illustrating an exemplary configuration of a train control system 100 installed on a typical train 800. The train control system 100 includes train information processing apparatuses 400-1 and 400-2, propulsion control devices 501-1 and 501-3, door control devices 502-1, 502-2, and 502-3, and brake control devices 503-1, 503-2, and 503-3. The train information processing apparatuses 400-1 and 400-2, the propulsion control devices 501-1 and 501-3, the door control devices 502-1, 502-2, and 502-3, and the brake control devices 503-1, 503-2, and 503-3 are connected to an intra-train network 600. The train information processing apparatuses 400-1 and 400-2 are connected, via the intra-train network 600, to devices, such as the propulsion control devices 501-1 and 501-3, the door control devices 502-1, 502-2, and 502-3, and the brake control devices 503-1, 503-2, and 503-3, installed on the train 800, and monitor and control the devices.

In FIG. 2, the train information processing apparatuses 400-1 and 400-2 correspond to the train information processing apparatuses 40-1 and 40-2 illustrated in FIG. 1, and the propulsion control devices 501-1 and 501-3, the door control devices 502-1, 502-2, and 502-3, and the brake control devices 503-1, 503-2, and 503-3 correspond to the vehicle devices 50-1 and 50-2 illustrated in FIG. 1. In the following description, the propulsion control devices 501-1 and 501-3, the door control devices 502-1, 502-2, and 502-3, and the brake control devices 503-1, 503-2, and 503-3 may be collectively simply referred to as devices. The train information processing apparatuses 400-1 and 400-2 collect, via the intra-train network 600, pieces of device information indicating, for example, states of the devices, and check operations or states of the devices. Additionally, the train information processing apparatuses 400-1 and 400-2 transmit to the devices, via the intra-train network 600, results of performing necessary calculations using the collected pieces of device information, thereby controlling the devices. In the train control system 100, the large number of devices installed on the train 800 are connected to the intra-train network 600 and integrally managed by the train information processing apparatuses 400-1 and 400-2, which each stand for a monitor apparatus.

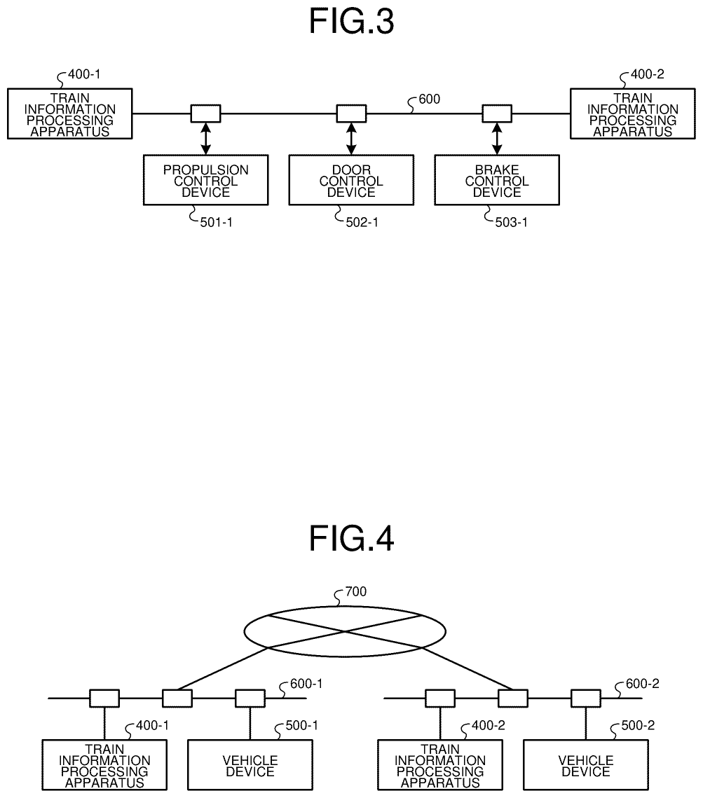

Usually, in a trial production stage or the like before starting an operation of the train 800 on which the train information processing apparatuses 400-1 and 400-2 and the devices are installed as illustrated in FIG. 2, a combination test with actual machines is performed to see whether the train information processing apparatuses 400-1 and 400-2 and the devices, which are connected to each other, operate without any problem. FIG. 3 is a first diagram illustrating an example of a typical combination test with actual machines. FIG. 3 illustrates an example in which the train information processing apparatuses 400-1 and 400-2, the propulsion control device 501-1, the door control device 502-1, and the brake control device 503-1 are directly connected to each other via the intra-train network 600 and are subjected to the combination test. In the example of FIG. 3, the train information processing apparatuses 400-1 and 400-2 and the devices are wiredly connected to each other, and thus do not undergo such a problem as a communication delay. However, the test cannot be performed unless all of the train information processing apparatuses 400-1 and 400-2 and the devices are prepared in the same place.

FIG. 4 is a second diagram illustrating an example of a typical combination test with actual machines. FIG. 4 illustrates an example in which the train information processing apparatus 400-1 and the vehicle device 500-1 connected to the intra-train network 600-1, and the train information processing apparatus 400-2 and the vehicle device 500-2 connected to the intra-train network 600-2 are connected to each other via the extra-train network 700 and are subjected to the combination test. In the example of FIG. 4, the combination test can be performed by using the train information processing apparatus 400-1 and the vehicle device 500-1, and the train information processing apparatus 400-2 and the vehicle device 500-2 installed at a remote location. However, the train information processing apparatus 400-1 and the vehicle device 500-1, and the train information processing apparatus 400-2 and the vehicle device 500-2 are connected to each other via the extra-train network 700, and thus will undergo such a problem as a communication delay. Additionally, there is a concern about a security problem because communication is performed even in the extra-train network 700 using data communication protocols used in the intra-train network 600-1 and 600-2 as it is. In FIG. 4, although the extra-train network 700 can be a dedicated network, the construction or use of the dedicated network increases costs.

In the present embodiment, a description will be given of a method by which the test information management system 10 reduces the influence of the communication delay and continuously performs the remote combination test even when the intra-train networks 60-1 and 60-2 are connected to each other via the extra-train network 70 as illustrated in FIG. 1.

In the test information management system 10 illustrated in FIG. 1, the train information processing apparatuses 40 periodically collect the pieces of device information of the vehicle devices 50, and manage and monitor the respective pieces of device information of the vehicle devices 50. Additionally, the train information processing apparatuses 40 generate pieces of control command information and the like to the vehicle devices 50 based on the pieces of device information collected from the vehicle devices 50, and transmit the pieces of control command information and the like to the vehicle devices 50. The train information processing apparatuses 40 may also be referred to as train information management apparatuses. In the example of FIG. 1, the train information processing apparatus 40-1 transmits and receives data to and from the vehicle devices 50-1 and 50-2, and manages operations of the vehicle devices 50-1 and 50-2. Additionally, the train information processing apparatus 40-2 transmits and receives data to and from the vehicle devices 50-1 and 50-2, and manages operations of the vehicle devices 50-1 and 50-2.

The vehicle devices 50 periodically transmit, to the train information processing apparatus 40, pieces of device information indicating their own states, response states to the pieces of control command information, and the like. Additionally, upon receiving the pieces of control command information from the train information processing apparatus 40, the vehicle devices 50 each operate based on the pieces of control command information.

Upon receiving data such as pieces of control command information from a corresponding one of the train information processing apparatuses 40 or pieces of device information from a corresponding one of the vehicle devices 50, each of the information conversion apparatuses 30 does not perform any processing when a destination of the data is in the same intra-train network 60 as the corresponding train information processing apparatus 40 or the corresponding vehicle device 50, and converts a communication protocol of the data and transmits the data whose communication protocol has been converted to the test information management apparatuses 20 when the destination of the data is the extra-train network 70. Additionally, upon receiving the data from the test information management apparatuses 20 in the extra-train network 70, each of the information conversion apparatuses 30 converts the communication protocol of the data and distributes the data whose communication protocol has been converted to the train information processing apparatus 40 or the vehicle device 50 in a corresponding one of the intra-train networks 60. The information conversion apparatus 30 manages addresses or the like of the apparatuses and the devices to be the destinations of the pieces of data, and performs destination management such that a data distribution destination can be uniquely identified.

Each of the test information management apparatuses 20 includes a device model execution unit capable of executing processing identical to that executed by the train information processing apparatus 40 and the vehicle device 50, and performs, on the basis of a communication state between the train information processing apparatus 40 and the vehicle device 50, control to distribute, to a transmission destination of the data, the data transmitted from a transmission source of the data or data obtained by the device model execution unit. Specifically, upon receiving the data from the information conversion apparatus 30, the test information management apparatus 20 registers the received data in a database. In response to receiving, from the information conversion apparatus 30, a data subscription request, the test information management apparatus 20 distributes the data to the information conversion apparatus 30 that is a request source of the data subscription request, upon updating the data that is a target of the data subscription request and registered. Additionally, the test information management apparatus 20 manages a communication delay between the test information management apparatus 20 and the information conversion apparatus 30 and estimates the communication delay. For example, the communication delay is delay time. The test information management apparatus 20 outputs the data to the device model execution unit capable of executing the processing identical to that of the train information processing apparatus 40 and the vehicle device 50, and the device model execution unit executes a device model using the data. When the estimated communication delay exceeds a predetermined delay threshold, the test information management apparatus 20 registers in the database a processing result of the device model execution unit as data, thereby causing the device model execution unit to perform substitution of the update of the data.

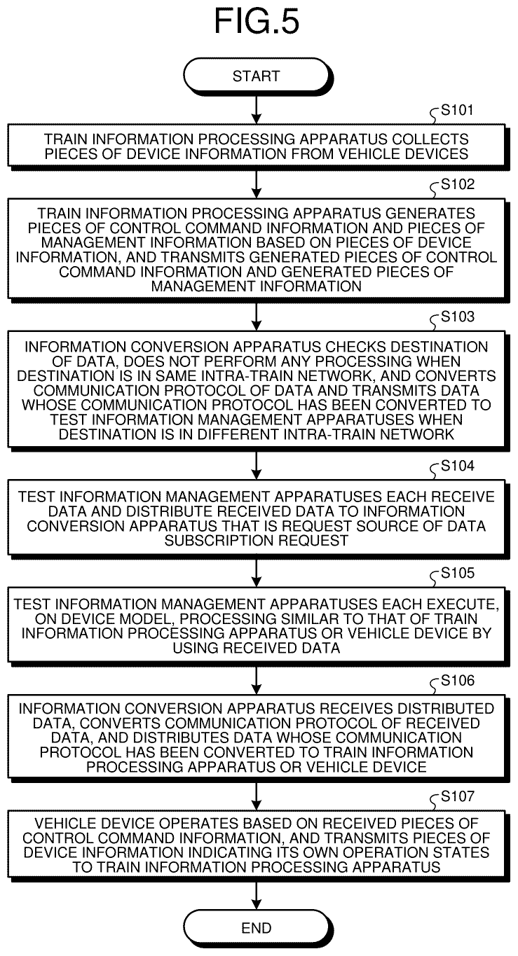

FIG. 5 is a flowchart illustrating operations of the test information management system 10 according to the first embodiment. A description will now be given, by way of example, of a case where the train information processing apparatus 40-1 controls the operations of the vehicle devices 50.

In the test information management system 10, the train information processing apparatus 40-1 collects pieces of device information from the vehicle devices 50 (step S101). The train information processing apparatus 40-1 directly acquires the pieces of device information from the vehicle device 50-1 because of being in the same intra-train network 60 as the vehicle device 50-1. The train information processing apparatus 40-1 acquires the pieces of device information from the vehicle device 50-2 through the test information management apparatuses 20 and the information conversion apparatus 30-1 via the extra-train network 70. The operations in the test information management apparatuses 20 are actually similar to operations in steps S104 and S105 to be described later although the flow of the data is opposite. The detailed description of the operations will not be given here.

The train information processing apparatus 40-1 generates pieces of control command information and pieces of management information based on the collected pieces of device information, and transmits the generated pieces of control command information and the generated pieces of management information to the vehicle devices 50 (step S102). The pieces of control command information are processing execution requests with which the train information processing apparatuses 40 provides the vehicle devices 50. The pieces of management information are pieces of information of results of processing the operation states of the vehicle devices 50. Note that, the pieces of data transmitted from the train information processing apparatus 40-1 to the vehicle devices 50 may be only one of the pieces of control command information and the pieces of management information.

The information conversion apparatus 30-1 checks the destination of the data received from the train information processing apparatus 40-1; when the destination is the vehicle device 50-1 in the same intra-train network 60-1 as the train information processing apparatus 40-1, does not perform any processing because the data directly arrives; and when the destination is the vehicle device 50-2 in the different intra-train network 60-2 from the train information processing apparatus 40-1, converts the communication protocol of the data and transmits the data whose communication protocol has been converted to the test information management apparatuses 20 in the extra-train network 70 (step S103). The information conversion apparatus 30-1 creates a routing table or the like in advance regarding to which network the train information processing apparatuses 40 and the vehicle devices 50, which are to be the destinations of the pieces of data, are connected. A method of creating the routing table in the information conversion apparatus 30-1 may be an existing typical method and is not particularly limited.

Each of the test information management apparatuses 20 registers the received data in the database, and when the received data is the data being the target of the data subscription request, distributes the received data to the information conversion apparatus 30 that is the request source of the data subscription request (step S104):

The test information management apparatus 20 executes, on the device model, processing similar to that of the train information processing apparatus 40 or the vehicle device 50 by using the received data (step S105). The device model can simulate and execute processing of the train information processing apparatus 40 or the vehicle device 50 as software.

Upon receiving the data distributed from the test information management apparatuses 20, the information conversion apparatus 30-2 converts the communication protocol of the received data and distributes the data whose communication protocol has been converted to the train information processing apparatus 40-2 or the vehicle device 50-2 (step S106).

The vehicle device 50-2 operates based on the pieces of control command information that is the received data, and transmits the pieces of device information indicating its own operation states to the train information processing apparatus 40-1 (step S107).

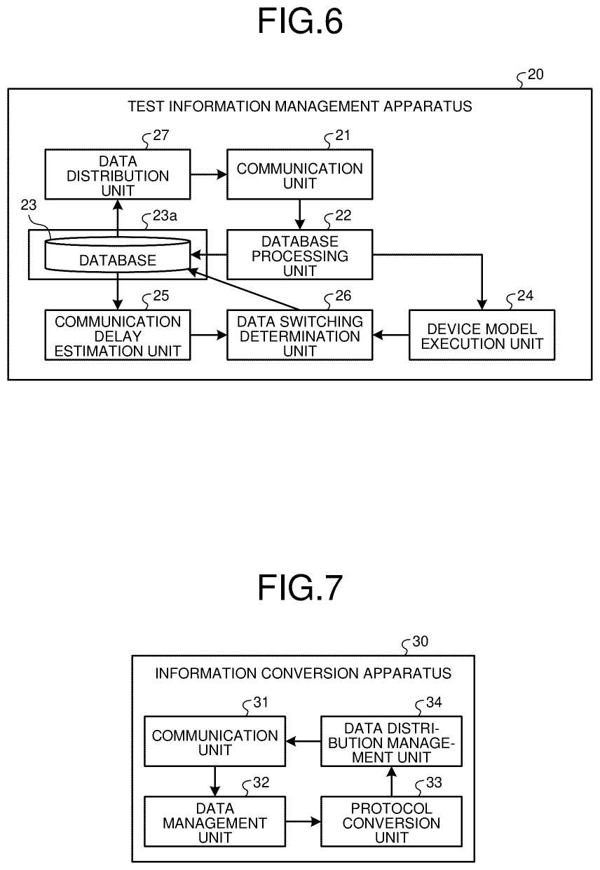

Next, a description will be given of configurations of the individual apparatuses constituting the test information management system 10. FIG. 6 is a diagram illustrating an exemplary configuration of each of the test information management apparatuses 20 according to the first embodiment. The test information management apparatus 20 includes a communication unit 21, a database processing unit 22, a storage unit 23a that stores the database 23, a device model execution unit 24, a communication delay estimation unit 25, a data switching determination unit 26, and a data distribution unit 27.

The communication unit 21 performs wireless communication with the information conversion apparatus 30, receives the data from the information conversion apparatus 30, and distributes the data to the information conversion apparatus 30. Specifically, the communication unit 21 transmits and receives the data whose transmission source or transmission destination is the train information processing apparatus 40 and the vehicle device 50.

The database processing unit 22 registers in the database 23 the data received by the communication unit 21. Additionally, the database processing unit 22 outputs the data received by the communication unit 21 to the device model execution unit 24.

The database 23 stored in the storage unit 23a is a storage area for storing the data received by the communication unit 21 and registered by the database processing unit 22 or the data obtained by the device model execution unit 24 and registered by the data switching determination unit 26. The storage unit 23a manages the state of each data and the operation time so as to see whether the data that is registered in the database 23 and is being subjected to the test is the data received by the communication unit 21 or the data updated by the device model execution unit 24. Consequently, when the test is performed in the test information management system 10, the storage unit 23a can provide later information about, for example, the time and timing at which the data obtained as a result of the device model execution unit 24 executing the device model is used.

The device model execution unit 24 can execute processing identical to that executed by the train information processing apparatus 40 and the vehicle device 50, and executes the device model using the data acquired from the database processing unit 22. The device model execution unit 24 individually executes different device models depending on the train information processing apparatuses 40 and the vehicle devices 50. Although FIG. 6 illustrates one device model execution unit 24 to simplify the description, the test information management apparatus 20 actually includes device model execution units 24 as many as the number of corresponding train information processing apparatuses 40 and vehicle devices 50. Note that, the device model execution unit 24 may have a format in which one device model execution unit 24 includes a plurality of device models corresponding to the train information processing apparatuses 40 and the vehicle devices 50 and can execute the plurality of device models. The device model execution unit 24 may be software itself that performs the operations of the train information processing apparatus 40 and the vehicle device 50. The device model execution unit 24 may perform processing in real time using the acquired data, or may use a result of performing processing in advance before the operation of the test information management system 10. The device model execution unit 24 outputs an execution result, that is, the data obtained as a result of executing the device model, to the data switching determination unit 26.

The communication delay estimation unit 25 monitors an update cycle of the data registered in the database 23, and estimates and manages a communication delay between the test information management apparatus 20 and the information conversion apparatus 30 in each intra-train network 60. The communication delay estimation unit 25 estimates delay time and outputs the estimated delay time to the data switching determination unit 26. Note that, the communication delay estimated by the communication delay estimation unit 25 may include a processing delay in each apparatus in addition to the delay in each intra-train network 60 and the extra-train network 70.

The data switching determination unit 26 performs, based on the delay time estimated by the communication delay estimation unit 25, control to register in the database 23 the data obtained by the device model execution unit 24, that is, the data that is the execution result of the device model execution unit 24. Specifically, when the delay time estimated by the communication delay estimation unit 25 exceeds a predetermined delay threshold, the data switching determination unit 26 registers in the database 23 the data that is the execution result of the device model execution unit 24. Consequently, the test information management apparatus 20 can provide a result of executing, by proxy, processing to be actually performed by the train information processing apparatus 40 and the vehicle device 50. Note that, regarding the operations of the communication delay estimation unit 25 and the data switching determination unit 26, the communication delay estimation unit 25 may determine whether the estimated delay time exceeds the predetermined delay threshold, and may notify, when the delay time exceeds the predetermined delay threshold, the data switching determination unit 26 of such a fact. In this case, upon receiving the notification, from the communication delay estimation unit 25, that the delay time exceeds the predetermined delay threshold, the data switching determination unit 26 registers in the database 23 the data that is the execution result of the device model execution unit 24.

The data distribution unit 27 manages the data subscription request of each of the information conversion apparatuses 30, and performs, when the data being the target of the data subscription request is updated in the database 23, control to distribute, via the communication unit 21, the data to the information conversion apparatus 30 that is the request source of the data subscription request. That is, the data distribution unit 27 performs control to distribute the data to the intra-train network 60-1 or the intra-train network 60-2. Note that as described above, the storage unit 23a manages whether the data registered in the database 23 is the data received by the communication unit 21 or the data updated by the device model execution unit 24. Thus, in distributing the data updated by the device model execution unit 24, the data distribution unit 27 may add, to the data, an information indicating that the distributed data is the data updated by the device model execution unit 24. Consequently, the information conversion apparatus 30, the train information processing apparatus 40, and the like that have received the data can grasp that the received data is the data updated by the device model execution unit 24, and can manage a test state in the test information management system 10.

FIG. 7 is a diagram illustrating an exemplary configuration of each of the information conversion apparatuses 30 according to the first embodiment. The information conversion apparatus 30 includes a communication unit 31, a data management unit 32, a protocol conversion unit 33, and a data distribution management unit 34.

The communication unit 31 performs wired communication with the train information processing apparatus 40 and the vehicle device 50 in the same intra-train network 60 as the corresponding information conversion apparatus 30, performs wireless communication with the test information management apparatuses 20 in the extra-train network 70, and transmits and receives the data to and from each apparatus and each device.

The data management unit 32 manages the destination of the data received by the communication unit 31, that is, the transmission destination. The data management unit 32 does not perform any processing when the destination of the data received by the communication unit 31 is in the same intra-train network 60 as the corresponding information conversion apparatus 30. The data management unit 32 outputs the data to the protocol conversion unit 33 when the destination of the data received by the communication unit 31 is to be transmitted to the different intra-train network 60 from the corresponding information conversion apparatus 30, that is, the extra-train network 70.

In transmitting the data from the intra-train network 60 to the extra-train network 70, the protocol conversion unit 33 performs protocol conversion to convert the communication protocol of the data. Additionally, in transmitting the data from the extra-train network 70 to the intra-train network 60, the protocol conversion unit 33 performs protocol conversion to convert the communication protocol of the data in an opposite way with respect to the above-described protocol conversion. That is, the protocol conversion unit 33 performs first protocol conversion to convert the communication protocol of the data when the transmission source of the data is in the same intra-train network 60 as the corresponding information conversion apparatus 30 and the transmission destination of the data is in the different intra-train network 60 from the corresponding information conversion apparatus 30. Additionally, the protocol conversion unit 33 performs second protocol conversion opposite to the first protocol conversion on the data when the transmission source of the data is in the different intra-train network 60 from the corresponding information conversion apparatus 30 and the transmission destination of the data is in the same intra-train network 60 as the corresponding information conversion apparatus 30. The protocol conversion unit 33 performs the first protocol conversion on the data to be transmitted to the test information management apparatus 20 and performs the second protocol conversion on the data received from the test information management apparatus 20.

The data distribution management unit 34 performs control to distribute, to the transmission destination via the communication unit 31, the data whose communication protocol has been converted by the protocol conversion unit 33. The transmission destination is the train information processing apparatus 40, or the vehicle device 50, or the test information management apparatus 20.

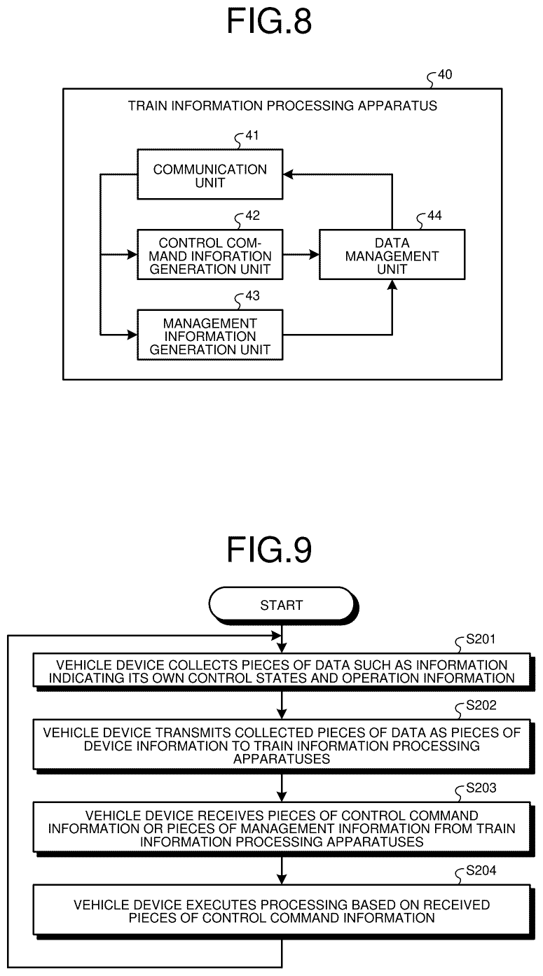

FIG. 8 is a diagram illustrating an exemplary configuration of each of the train information processing apparatuses 40 according to the first embodiment. The train information processing apparatus 40 includes a communication unit 41, a control command information generation unit 42, a management information generation unit 43, and a data management unit 44.

The communication unit 41 transmits and receives data to and from the vehicle devices 50 and the information conversion apparatus 30. The control command information generation unit 42 generates pieces of control command information that are the processing execution requests directed to the vehicle devices 50, based on the pieces of device information that are the pieces of data received from the vehicle devices 50. The management information generation unit 43 aggregates the states of the vehicle devices 50 based on the pieces of device information that are the pieces of data received from the vehicle devices 50, and generates pieces of management information of the vehicle devices 50 that are pieces of information obtained as results of processing the operation states of the vehicle devices 50. The data management unit 44 stores the pieces of control command information generated by the control command information generation unit 42 and the pieces of management information generated by the management information generation unit 43, and performs control to transmit the pieces of information to each vehicle device 50 via the communication unit 41.

Next, a description will be given of operations of the individual apparatuses constituting the test information management system 10. FIG. 9 is a flowchart illustrating operations of each of the vehicle devices 50 according to the first embodiment. As described above, the vehicle device 50 corresponds to the propulsion control device 501-1, the door control device 502-1, the brake control device 503-1, and the like, which are installed on the train 800.

The vehicle device 50 collects pieces of data such as information indicating its own control states and operation information (step S201). The vehicle device 50 transmits the collected pieces of data as pieces of device information to the train information processing apparatuses 40 (step S202). When the vehicle device 50 transmits the pieces of device information to the train information processing apparatus 40 in the different intra-train network 60 from itself, the pieces of device information actually pass through the information conversion apparatus 30 and the test information management apparatuses 20 in the extra-train network 70. The vehicle device 50 receives the pieces of control command information or the pieces of management information from the train information processing apparatuses 40 (step S203). When the vehicle device 50 receives the pieces of control command information or the pieces of management information from the train information processing apparatus 40 in the different intra-train network 60 from itself, the pieces of control command information or the pieces of management information actually pass through the test information management apparatuses 20 in the extra-train network 70 and the information conversion apparatus 30. The vehicle device 50 executes processing based on the received pieces of control command information (step S204). Consequently, the vehicle device 50 controls its own operations. The vehicle device 50 periodically and repeatedly executes the above-described operations.

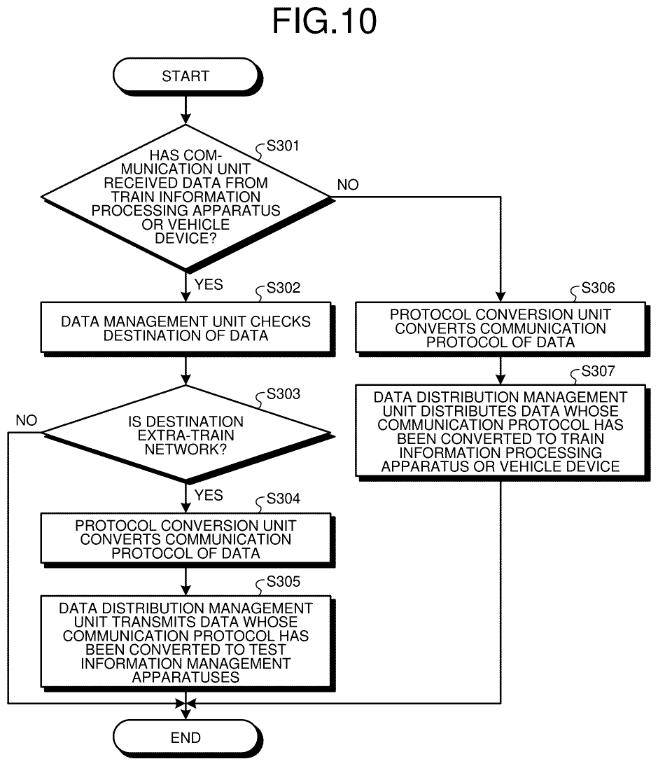

FIG. 10 is a flowchart illustrating operations of each of the information conversion apparatuses 30 according to the first embodiment. The information conversion apparatus 30 performs the data communication protocol conversion in such a way that direction of the conversion is switched oppositely between a case where the data is received from the intra-train network 60, that is, the train information processing apparatus 40 or the vehicle device 50 and a case where the data is received from the extra-train network 70, that is, the test information management apparatuses 20.

When the communication unit 31 has received the data from the train information processing apparatus 40 or the vehicle device 50 (step S301: Yes), the data management unit 32 checks the destination of the data (step S302). When the destination of the data is a local network, that is, the intra-train network 60 (step S303, No), the data management unit 32 does not perform any processing. When the destination of the data is the Internet, that is, the extra-train network 70 (step S303: Yes), the data management unit 32 outputs the data to the protocol conversion unit 33. The protocol conversion unit 33 converts the communication protocol of the data from the protocol of the intra-train network 60 to the protocol of the extra-train network 70 (step S304). The protocol conversion unit 33 outputs the data whose communication protocol has been converted to the data distribution management unit 34. The data distribution management unit 34 transmits the data whose communication protocol has been converted to the test information management apparatuses 20 via the communication unit 31 (step S305).

When the communication unit 31 receives the data from the test information management apparatuses 20 (step S301: No), the data management unit 32 outputs the data to the protocol conversion unit 33 since the destination of the data is the local network, that is, the intra-train network 60. The protocol conversion unit 33 converts the communication protocol of the data from the protocol of the extra-train network 70 to the protocol of the intra-train network 60 (step S306). The protocol conversion unit 33 outputs the data whose communication protocol has been converted to the data distribution management unit 34. The data distribution management unit 34 distributes the data whose communication protocol has been converted to the train information processing apparatus 40 or the vehicle device 50 via the communication unit 31 (step S307).

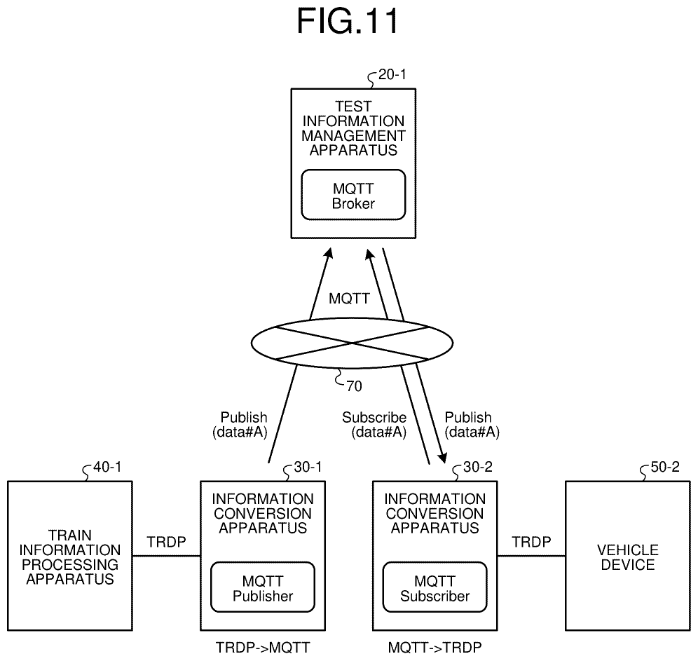

FIG. 11 is a diagram illustrating an example of the data communication protocol conversion performed by each of the information conversion apparatuses 30 according to the first embodiment. FIG. 11 illustrates, as the communication protocols of the data transmitted and received in the test information management system 10, an example in which a Train Real-time Data Protocol (TRDP) is used in the intra-train network 60 and a Message Queueing Telemetry Transport (MQTT) is used in the extra-train network 70. In the example of FIG. 11, the protocol conversion unit 33 of each of the information conversion apparatuses 30 converts the communication protocol of the data from TRDP to MOTT or from MQTT to TRDP. Specifically, FIG. 11 illustrates an example in which the data is transmitted from the train information processing apparatus 40-1 to the vehicle device 50-2.

In this case, the information conversion apparatus 30-2 that is an MOTT subscriber grasps in advance data #A to be distributed to the vehicle device 50-2, and makes a data subscription request (subscribe) of the data #A to the test information management apparatus 20-1 that is an MOTT broker. Upon receiving the data #A from the train information processing apparatus 40-1, the information conversion apparatus 30-1 that is an MOTT Publisher converts the communication protocol of the data #A from TRDP to MOTT and distributes (publishes) the data #A whose communication protocol has been converted to the test information management apparatus 20-1. When the data #A in the database 23 is updated in response to the reception of the data #A from the information conversion apparatus 30-1, the test information management apparatus 20-1 distributes (publishes) the data #A to the information conversion apparatus 30-2. Upon receiving the data #A from the test information management apparatus 20-1, the information conversion apparatus 30-2 converts the communication protocol of the data #A from MOTT to TRDP and distributes the data #A whose communication protocol has been converted to the vehicle device 50-2.

As described above, the test information management system 10 eliminates the need for connecting the apparatuses and the devices to each other via the dedicated network since the data is distributed through the test information management apparatus 20, and facilitates the construction of the network line since the intra-train network 60 only needs to be connected to the extra-train network 70. Additionally, the test information management system 10 can ensure data safety from the viewpoint of security and the like since a general-purpose communication protocol such as MOTT can be used instead of being TROP that is the communication protocol dedicated to the intra-train network 60 when the data passes through the extra-train network 70.

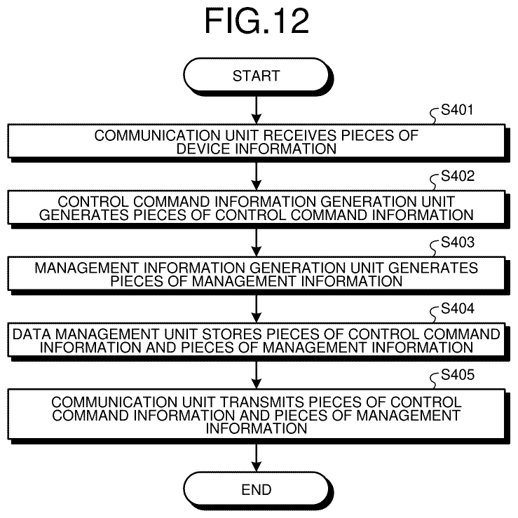

FIG. 12 is a flowchart illustrating the operations of each of the train information processing apparatuses 40 according to the first embodiment. In the train information processing apparatus 40, the communication unit 41 receives the pieces of device information from the vehicle devices 50 (step S401). The control command information generation unit 42 generates pieces of control command information based on the pieces of device information received by the communication unit 41 (step S402). The management information generation unit 43 generates pieces of management information based on the pieces of device information received by communication unit 41 (step S403). The data management unit 44 stores and manages the pieces of control command information generated by the control command information generation unit 42 and the pieces of management information generated by the management information generation unit 43 (step S404). The communication unit 41 acquires the pieces of control command information and the pieces of management information from the data management unit 44, and transmits the pieces of control command information and the pieces of management information to the vehicle device 50, which is the transmission source of the pieces of device information, as the destination (step S405). The train information processing apparatus 40 generates and transmits pieces of control command information and pieces of management information based on the pieces of vehicle device data collected within a certain cycle;

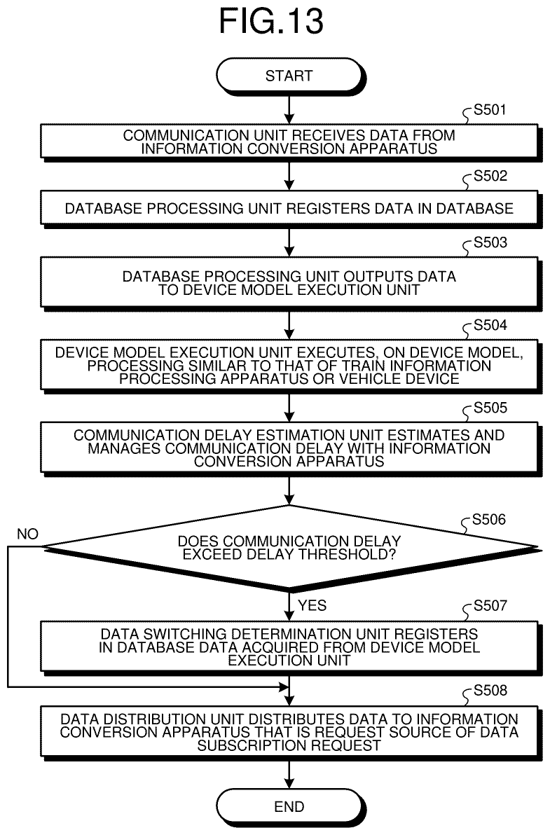

FIG. 13 is a first flowchart illustrating the operations of each of the test information management apparatuses 20 according to the first embodiment. The communication unit 21 receives the data from the information conversion apparatus 30 (step S501). The database processing unit 22 registers in the database 23 the data received by the communication unit 21 (step S502) Additionally, the database processing unit 22 outputs the data received by the communication unit 21 to the device model execution unit 24 (step S503). The device model execution unit 24 executes the device model using the data acquired from the database processing unit 22, and executes, on the device model, processing similar to that of the train information processing apparatus 40 or the vehicle device 50 (step S504). The device model execution unit 24 outputs the data obtained as a result of executing the device model to the data switching determination unit 26.

The communication delay estimation unit 25 monitors the update cycle of the data in the database 23, and estimates and manages a communication delay with the information conversion apparatus 30 (step S505). The communication delay estimation unit 25 outputs the estimated communication delay to the data switching determination unit 26. The data switching determination unit 26 compares the communication delay estimated by the communication delay estimation unit 25 with a predetermined delay threshold (step S506). When the communication delay exceeds the delay threshold (step S506: Yes), the data switching determination unit 26 registers in the database 23 the data acquired from the device model execution unit 24 (step S507). When the communication delay does not exceed the delay threshold (step S506: No), the data switching determination unit 26 skips the operation in step S507. When the data being the target of the data subscription request is updated in the database 23, the data distribution unit 27 distributes, via the communication unit 21, the data to the information conversion apparatus 30 that is the request source of the data subscription request (step S508).

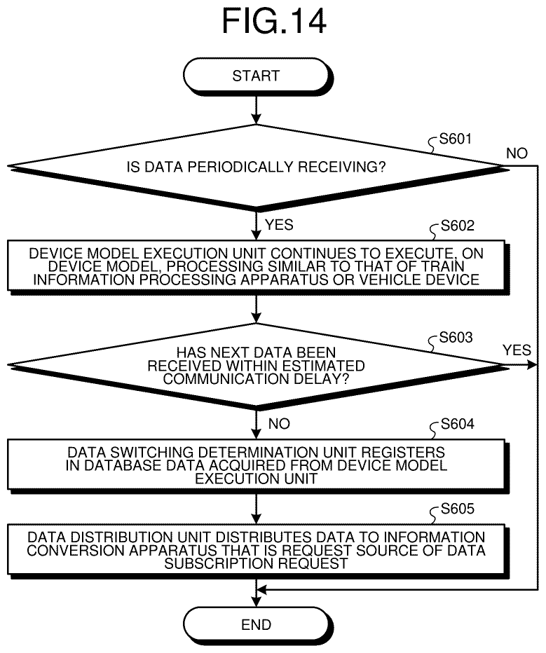

FIG. 14 is a second flowchart illustrating the operations of each of the test information management apparatuses 20 according to the first embodiment. FIG. 14 illustrates operations of the test information management apparatus 20 in periodically receiving the data from the information conversion apparatus 30. When the test information management apparatus 20 is periodically receiving the data from the information conversion apparatus 30 (step S601: Yes), the device model execution unit 24 continues to execute, on the device model, processing similar to that of the train information processing apparatus 40 or the vehicle device 50 (step S602). That is, even if the data is not actually acquired from the database processing unit 22, the device model execution unit 24 executes, on the device model, processing similar to that of the train information processing apparatus 40 or the vehicle device 50 based on, for example the previously acquired data. The device model execution unit 24 outputs the data obtained as a result of executing the device model to the data switching determination unit 26.

The communication delay estimation unit 25 monitors the update cycle of the data in the database 23 and checks whether the test information management apparatus 20 has received next data within the estimated communication delay (step S603). When the test information management apparatus 20 has not received the next data within the estimated communication delay (step S603: No), the communication delay estimation unit 25 notifies the data switching determination unit 26 of such a fact. Based on the notification, from the communication delay estimation unit 25, that the test information management apparatus 20 has not received the next data within the estimated communication delay, the data switching determination unit 26 registers in the database 23 the data acquired from the device model execution unit 24 (step S604). When the data being the target of the data subscription request is updated in the database 23, the data distribution unit 27 distributes, via the communication unit 21, the data to the information conversion apparatus 30 that is the request source of the data subscription request (step S605). Note that, when the test information management apparatus 20 is not periodically receiving the data from the information conversion apparatus 30 (step S601: No), or when the test information management apparatus 20 has received the next data within the estimated communication delay (step S603: Yes), the operation in this case is the same as the normal operation, and thus the operations illustrated in FIG. 14 end.

As described above, the test information management apparatus 20 gets the result of the device model execution unit 24 executing the device model as a substitute for an actual result of the train information processing apparatus 40 or the vehicle device 50 performing processing. Consequently, the test information management system 10 can continuously perform the remote combination test with actual machines using the train information processing apparatus 40 and the vehicle device 50 even when the communication delay increases in the system configuration in which the plurality of intra-train networks 60 are connected to each other via the extra-train network 70. That is, the test information management apparatus 20 manages, as the communication states, a communication delay in transmission and reception of the data between the test information management apparatus 20 and the intra-train network 60-1 and a communication delay in transmission and reception of the data between the test information management apparatus 20 and the intra-train network 60-2, and distributes the data obtained by the device model execution unit 24 to a transmission destination of the data when each of the communication delays exceeds a predetermined delay threshold. The test information management apparatus 20 registers, in the database 23, the data transmitted from the transmission source of the data or the data obtained by the device model execution unit 24, and distributes, to the request source of the data subscription request for the data, the data that is the target of the data subscription request and is registered in the database 23.

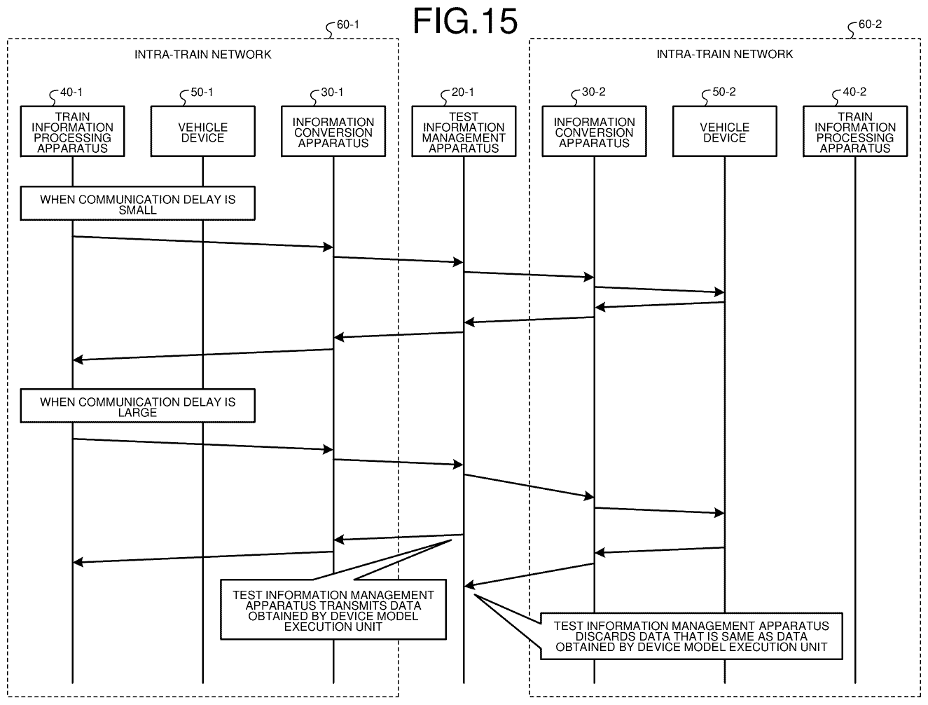

FIG. 15 is a first diagram illustrating a concept in which the test information management apparatus 20 according to the first embodiment distributes the data obtained as the result of the device model execution unit 24 executing the device model. FIG. 15 is a diagram corresponding to the operations of the test information management apparatus 20 illustrated in the flowchart of FIG. 13. FIG. 15 illustrates an example in which the data such as the pieces of control command information is transmitted from the train information processing apparatus 40-1 in the intra-train network 60-1 to the vehicle devices 50-2 in the intra-train network 60-2, and the data such as the pieces of device information as a response is transmitted from the vehicle devices 50-2 to the train information processing apparatus 40-1. As illustrated in FIG. 15, when the communication delay is small, the test information management apparatus 20-1 distributes the data transmitted from the train information processing apparatus 40-1 or the vehicle device 50-2. On the other hand, when the communication delay is large, in order to continue the system operation, the test information management apparatus 20-1 registers in the database 23 the data that is the execution result of the device model execution unit 24, and distributes the data that is the execution result of the device model execution unit 24 to the train information processing apparatus 40-1 in the intra-train network 60-1 instead of the pieces of device information, that is, the data obtained as the operation results of the vehicle device 50-2 in the intra-train network 60-2. When the data arriving late due to the influence of the communication delay is the same as the data that is the execution result of the device model execution unit 24, the test information management apparatus 20-1 discards the data. When the data arriving late due to the influence of the communication delay is different from the data that is the execution result of the device model execution unit 24, the test information management apparatus 20-1 updates the data in the database 23 and distributes the updated data to the train information processing apparatus 40-1 in the intra-train network 60-1.

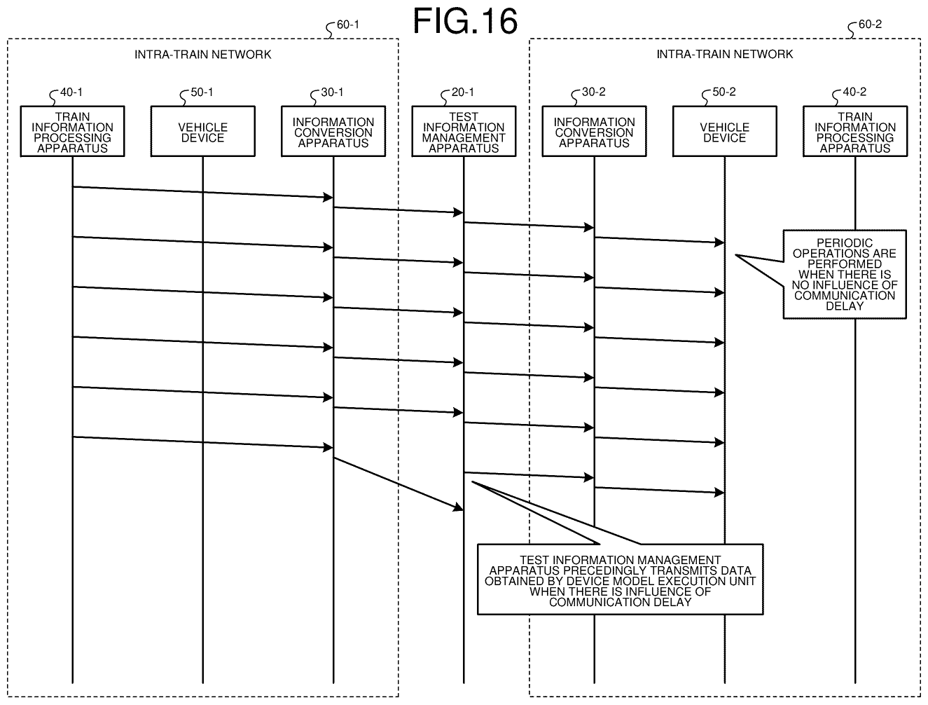

FIG. 16 is a second diagram illustrating a concept in which the test information management apparatus 20 according to the first embodiment distributes data obtained as the result of the device model execution unit 24 executing the device model. FIG. 16 is a diagram corresponding to the operations of the test information management apparatus 20 illustrated in the flowchart of FIG. 14. FIG. 16 illustrates an example in which data is periodically transmitted from the train information processing apparatus 40-1 in the intra-train network 60-1 to the vehicle device 50-2 in the intra-train network 60-2. As illustrated in FIG. 16, the test information management apparatus 20-1 monitors periodically receiving data and estimates a communication delay. When the test information management apparatus 20-1 cannot receive the data that is to be received at a constant cycle, the test information management apparatus 20-1 precedingly transmits the data that is the execution result of the device model execution unit 24 in order to guarantee periodic data transmission without waiting for actual reception of the data from the train information processing apparatus 40-1. Consequently, the test information management apparatus 20-1 can reduce the influence of the communication delay.

Note that, although the present embodiment has described the case where the independent information conversion apparatus 30 converts the communication protocol in the test information management system 10, the present disclosure is not limited thereto. The test information management system 10 may install the function of the information conversion apparatus 30 on the train information processing apparatus 40 or the vehicle device 50.

Additionally, although the present embodiment has described the case where the test information management apparatuses 20-1 and 20-2 perform the similar operations, but the present disclosure is not limited thereto. For example, when the train information processing apparatuses 40 and the vehicle devices 50 that are included in the test information management system 10 are large in number, the test information management apparatuses 20-1 and 20-2 may halve the train information processing apparatuses 40 and the vehicle devices 50 for which the device model is to be executed by the device model execution unit 24 and execute the device models corresponding to the different train information processing apparatuses 40 and the different vehicle devices 50.

Additionally, although the present embodiment has described, by way of example, as an application of the test information management system 10, the combination test with actual machines, such as the train information processing apparatuses 40 and the vehicle devices 50 that are used in a train, that is, apparatuses and devices used in the field of railroad, the present disclosure is not limited thereto. The test information management system 10 can also be applied to a combination test with actual machines such as devices used in other fields such as automobiles, robots, and factory machines, Additionally, the test information management system 10 can be applied not only to a combination test with actual machines such as apparatuses and devices used in a newly designed train but also, for example, to a combination test with actual machines for confirming an effect of a countermeasure against a failure that has occurred during operation of the train.

Next, a description will be given of a hardware configuration of each apparatus constituting the test information management system 10 according to the first embodiment. In the test information management apparatus 20, the communication unit 21 is a communicator capable of performing, in the extra-train network 70, wireless communication with the information conversion apparatus 30. The storage unit 23a is a memory. The database processing unit 22, the device model execution unit 24, the communication delay estimation unit 25, the data switching determination unit 26, and the data distribution unit 27 are implemented by processing circuitry. The processing circuitry may include a memory that stores a program and a processor that executes the program stored in the memory or may include dedicated hardware. The processing circuitry is also referred to as a control circuit.

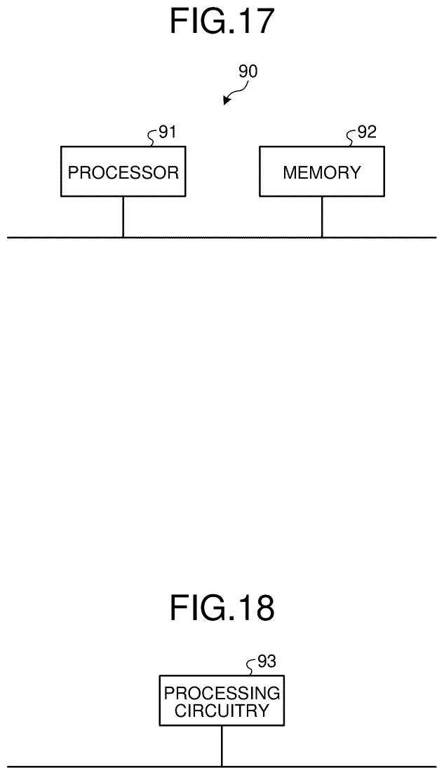

FIG. 17 is a diagram illustrating an example of a configuration of processing circuitry 90 in a case where a processor 91 and a memory 92 implement the processing circuitry of the test information management apparatus 20 according to the first embodiment. The processing circuitry 90 illustrated in FIG. 17 is a control circuit and includes the processor 91 and the memory 92. In the case where the processing circuitry 90 includes the processor 91 and the memory 92, each function of the processing circuitry 90 is implemented by software, firmware, or a combination of software and firmware. The software or the firmware is described as a program and stored in the memory 92. In the processing circuitry 90, the processor 91 reads and executes the program stored in the memory 92 to implement each function. That is, the processing circuitry 90 includes the memory 92 for storing a program with which processing of the test information management apparatus 20 is executed as a result. It can also be said that this program is a program for causing the test information management apparatus 20 to execute each function implemented by the processing circuitry 90. This program may be provided by a storage medium storing the program or may be provided by other means such as a communication medium.

It can also be said that the program is a program for causing the test information management apparatus 20 to executes a train information processing step of, by the train information processing apparatus 40, transmitting and receiving, in a first intra-train network, the data to and from the vehicle device 50 in the second intra-train network and managing the operations of the vehicle device 50; and a test information management step of, by the test information management apparatus 20 including the device model execution unit 24 capable of executing processing identical to processing of the train information processing apparatus 40 and the vehicle device 50, performing control to distribute the data transmitted from the transmission source of the data or the data obtained by the device model execution unit 24 to the transmission destination of the data based on a communication state between the train information processing apparatus 40 and the vehicle device 50.

Here, the processor 91 is, for example, a Central Processing Unit (CPU), a processing unit, an arithmetic unit, a microprocessor, a microcomputer, a Digital Signal Processor (DSP), or the like. Additionally, the memory 92 corresponds to, for example, a nonvolatile or volatile semiconductor memory such as a Random Access Memory (RAM) a Read Only Memory (ROM), a flash memory, an Erasable Programmable ROM (EPROM), or an Electrically EPROM (EEPROM, registered trademark), a magnetic disk, a flexible disk, an optical disk, a compact disk, a mini disk, a Digital Versatile Disc (DVD), or the like.

FIG. 18 is a diagram illustrating an example of a configuration of processing circuitry 93 in a case where dedicated hardware implements the processing circuitry of the test information management apparatus 20 according to the first embodiment. The processing circuitry 93 illustrated in FIG. 18 corresponds to, for example, a single circuit, a combined circuit, a programmed processor, a parallel-programmed processor, an Application Specific Integrated Circuit (ASIC), a Field Programmable Gate Array (FPGA), or a combination thereof. Some functions of the processing circuitry 93 may be implemented by dedicated hardware, and the other functions may be implemented by software or firmware. In this manner, the processing circuitry 93 can implement the above-described functions using dedicated hardware, software, firmware, or a combination thereof.

Although the hardware configuration of the test information management apparatus 20 has been described, the same applies to the hardware configurations of the information conversion apparatus 30 and the train information processing apparatus 40. In the information conversion apparatus 30, the communication unit 31 is a communicator capable of performing wireless communication with the test information management apparatus 20 in the extra-train network 70 and capable of performing wired communication with the train information processing apparatus 40 and the vehicle device 50 in the intra-train network 60. The data management unit 32, the protocol conversion unit 33, and the data distribution management unit 34 are implemented by processing circuitry. In the train information processing apparatus 40, the communication unit 41 is a communicator capable of wired communication with the information conversion apparatus 30 in the intra-train network 60. The control command information generation unit 42, the management information generation unit 43, and the data management unit 44 are implemented by processing circuitry. As in the test information management apparatus 20, the processing circuitry may include a memory that stores a program and a processor that executes the program stored in the memory or may include dedicated hardware. The processing circuitry is also referred to as a control circuit.

As described above, according to the present embodiment, in the test information management system 10, the test information management apparatus 20 in the extra-train network 70 monitors a communication delay with the information conversion apparatus 30 in the intra-train network 60, and uses the data obtained as the result of executing, on the device model, processing similar to that of the train information processing apparatus 40 or the vehicle device 50 when the communication delay exceeds the predetermined delay threshold. Consequently, the test information management system 10 can continuously perform the remote combination teat with actual machines. The test information management system 10 can reduce the influence of the communication delay and continuously perform the combination test even when the devices to be subjected to the combination test are present in different networks and undergo the communication delay. The test information management system 10 can be applied to a combination test with actual machines used in a train system requiring real-time properties.

Additionally, the test information management system 10 enables the execution of communication with data safety secured without using a dedicated network since the communication protocol of the data is converted when the data is transmitted to the extra-train network 70. Additionally, the test information management system 10 facilitates system construction because the test information management system 10 can be a system via a database on a cloud.

### Second Embodiment

In the first embodiment, when transmitting the data to the test information management apparatus 20 in the extra-train network 70, the information conversion apparatus 30 converts the communication protocol of the data and then transmits the data whose communication protocol has been converted. In a second embodiment, a description will be given of a case where the information conversion apparatus further extracts and transmits a difference data between the latest data and the previous data.

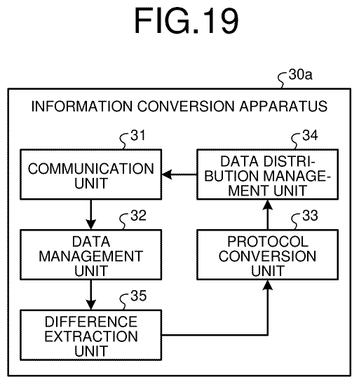

FIG. 19 is a diagram illustrating an exemplary configuration of an information conversion apparatus 308 according to the second embodiment. The information conversion apparatus 30a illustrated in FIG. 19 has a configuration in which a difference extraction unit 35 is added to the information conversion apparatus 30 of the first embodiment illustrated in FIG. 7. The difference extraction unit 35 extracts a difference data between the latest data received by the communication unit 31 and the data previously received by the communication unit 31.

The protocol conversion unit 33 performs data communication protocol conversion on the difference data extracted by the difference extraction unit 35, Additionally, the protocol conversion unit 33 performs data communication protocol conversion on the difference data when the data received by the communication unit 31 is the difference data.

The data distribution management unit 34 transmits the difference data, which has been extracted by the difference extraction unit 35 and subjected to the protocol conversion by the protocol conversion unit 33, to the test information management apparatus 20 in the extra-train network 70 via the communication unit 31. Additionally, the data distribution management unit 34 combines the difference data, which has been received by the communication unit 31 and subjected to the protocol conversion by the protocol conversion unit 33, with the previously received data to restore the original data. The original data is the latest data before the difference data is extracted by the information conversion apparatus 308 in each of the intra-train networks 60 different from each other.

Note that although not illustrated, the test information management system 10 according to the second embodiment has a configuration in which the information conversion apparatuses 30-1 and 30-2 of the test information management system 10 illustrated in FIG. 1 are replaced with information conversion apparatuses 30a-1 and 30a-2 having the same configuration as the information conversion apparatus 30a.

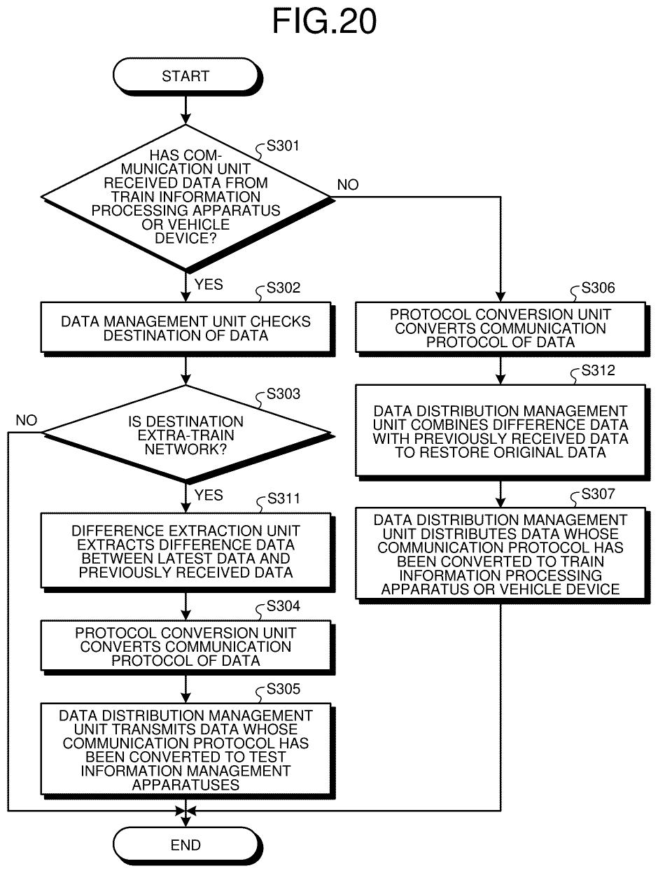

FIG. 20 is a flowchart illustrating operations of the information conversion apparatus 30a according to the second embodiment. The flowchart illustrated in FIG. 20 represents addition of steps S311 and S312 to the flowchart illustrating the operations of the information conversion apparatus 30 of the first embodiment illustrated in FIG. 10. In the information conversion apparatus 30a, when the destination of the data is the Internet, that is, the extra-train network 70 (step 303: Yes), the data management unit 32 outputs the data to the difference extraction unit 35. The difference extraction unit 35 extracts a difference data between the latest data and the previously received data (step S311). The difference extraction unit 35 outputs the extracted difference data to the protocol conversion unit 33.

Additionally, the protocol conversion unit 33 converts the communication protocol of the data from the protocol of the extra-train network 70 to the protocol of the intra-train network 60 (step S306). The protocol conversion unit 33 outputs the data whose communication protocol has been converted to the data distribution management unit 34. Note that, in practice, the data to be converted by the protocol conversion unit 33 in step S306 is the difference data. The data distribution management unit 34 combines the difference data with the previously received data to restore the original data (step S312). The data distribution management unit 34 distributes the data whose communication protocol has been converted to the train information processing apparatus 40 or the vehicle device 50 via the communication unit 31 (step S307).

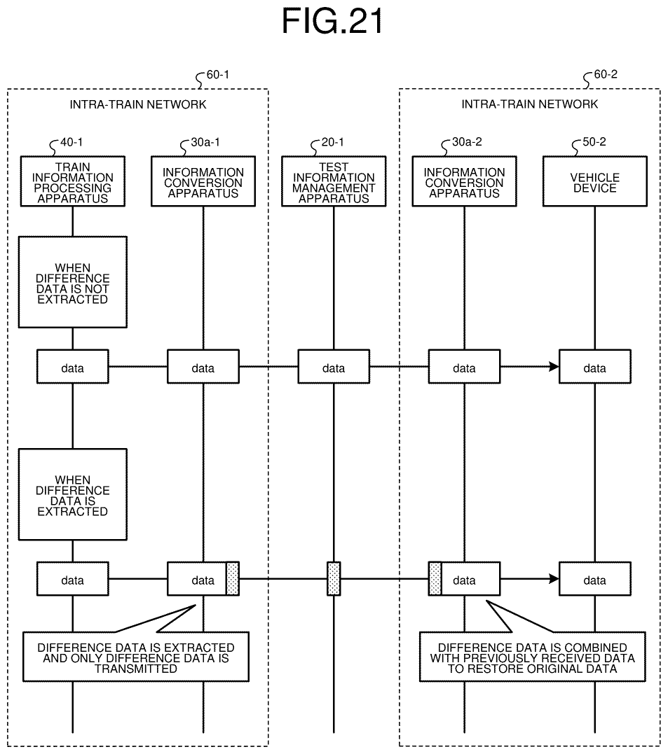

FIG. 21 is a diagram illustrating a concept in which a difference data is extracted from the data received by the information conversion apparatus 30a and only the difference data is transmitted and received in the test information management system 10 according to the second embodiment. FIG. 21 illustrates an example in which the data is distributed from the intra-train network 60-1 to the intra-train network 60-2. In FIG. 21, when the difference data is not extracted, the operations are the same as those of the information conversion apparatus 30 of the first embodiment. In this case, the data of the same size is transmitted from the train information processing apparatus 40-1 in the intra-train network 60-1 to the vehicle device 50-2 in the intra-train network 60-2. In FIG. 21, when the difference data is extracted, the information conversion apparatus 30a-1 extracts a portion of the data updated from the previously transmitted data, that is, the difference data, and transmits only the difference data. The test information management apparatus 20-1 performs control to distribute the difference data to the information conversion apparatus 30a-2. The information conversion apparatus 308-2 combines the difference data received from the test information management apparatus 20-1 with the previously received data to restore the original data, That is, the information conversion apparatuses 30a-1 and 30a-2 each extract, from the latest data, the difference data between the latest data and the previously transmitted data, convert the communication protocol of the difference data, and transmit the difference data whose communication protocol has been converted, and also convert the communication protocol of the difference data received, and combine the difference data whose communication protocol has been converted with the previously received data to restore the latest data.

In the present embodiment, the difference extraction unit 35 extracts, from first latest data to be transmitted to the test information management apparatus 20, first difference data between the first latest data and first previously transmitted data. The protocol conversion unit 33 performs first protocol conversion on the first difference data extracted by the difference extraction unit 35. The data distribution management unit 34 performs control to distribute, via the communication unit 31, the first difference data subjected to the first protocol conversion in the protocol conversion unit 33. Additionally, when the communication unit 31 receives, from the test information management apparatus 20, second difference data extracted by another information conversion apparatus 308, the protocol conversion unit 33 performs second protocol conversion on the second difference data. The data distribution management unit 34 performs control to combine the second difference data subjected to the second protocol conversion in the protocol conversion unit 33 with second previously received data to restore second latest data, and to distribute the second latest data via the communication unit 31.

As described above, in the second embodiment, the test information management system 10 can compress the communication data amount and shorten the communication delay as compared with the test information management system 10 of the first embodiment since the information conversion apparatus 30a transmits and receives only the difference data. Note that, since the data transmitted and received in the test information management system 10 includes various types of data, the information conversion apparatus 30a may collectively transmit pieces of difference data as one data set or may transmit each difference data as one data in accordance with the types of data when extracting the difference data.

The hardware configuration of the information conversion apparatus 30a is similar to the hardware configuration of the information conversion apparatus 30 of the first embodiment. In the information conversion apparatus 30a, the communication unit 31 is a communicator capable of performing wireless communication with the test information management apparatus 20 in the extra-train network 70 and capable of performing wired communication with the train information processing apparatus 40 and the vehicle device 50 in the intra-train network 60. The data management unit 32, the protocol conversion unit 33, the data distribution management unit 34, and the difference extraction unit 35 are implemented by processing circuitry. The processing circuitry may include a memory that stores a program and a processor that executes the program stored in the memory or may include dedicated hardware. The processing circuitry is also referred to as a control circuit.

### Third Embodiment

The test information management systems 10 according to the first and second embodiments each have the configuration in which the test information management apparatuses 20-1 and 20-2, that is, a plurality of test information management apparatuses 20 are present in the extra-train network 70. Thus, the information conversion apparatus 30 of the first embodiment and the information conversion apparatus 30a of the second embodiment can select, in accordance with a communication delay with each test information management apparatus 20, data to be used.

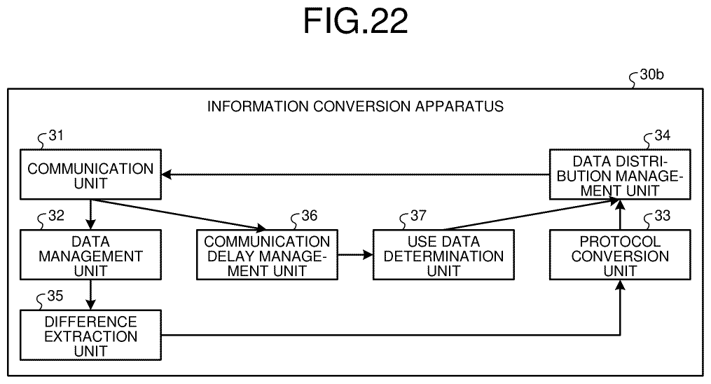

FIG. 22 is a diagram illustrating an exemplary configuration of an information conversion apparatus 30b according to a third embodiment. The information conversion apparatus 30b illustrated in FIG. 22 has a configuration in which a communication delay management unit 36 and a use data determination unit 37 are added to the information conversion apparatus 30a of the second embodiment illustrated in FIG. 19. The communication delay management unit 36 measures and manages communication delays between the information conversion apparatus 30b and the plurality of test information management apparatuses 20. Based on the communication delays measured by the communication delay management unit 36, the use data determination unit 37 selects and uses data received from one of the test information management apparatuses 20 with a smaller communication delay. The use data determination unit 37 discards data having a larger communication delay from among the pieces of data received from the test information management apparatuses 20.

Note that although not illustrated, the test information management system 10 according to the third embodiment has a configuration in which the information conversion apparatuses 30-1 and 30-2 of the test information management system 10 illustrated in FIG. 1 are replaced with information conversion apparatuses 30b-1 and 30b-2 having the same configuration as the information conversion apparatus 30b.

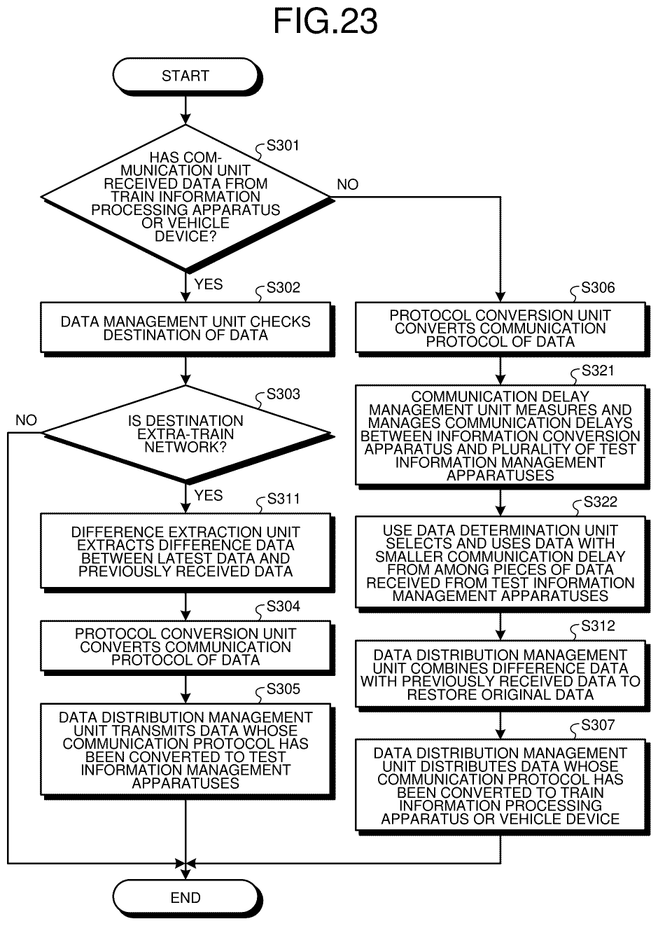

FIG. 23 is a flowchart illustrating operations of the information conversion apparatus 30b according to the third embodiment. The flowchart illustrated in FIG. 23 represents addition of steps S321 and S322 to the flowchart illustrating the operations of the information conversion apparatus 30a of the second embodiment illustrated in FIG. 20. The communication delay management unit 36 measures and manages the communication delays between the information conversion apparatus 30b and the plurality of test information management apparatuses 20 (step S321). The use data determination unit 37 selects and uses data with a smaller communication delay from among pieces of data received from the test information management apparatuses 20 (step S322),

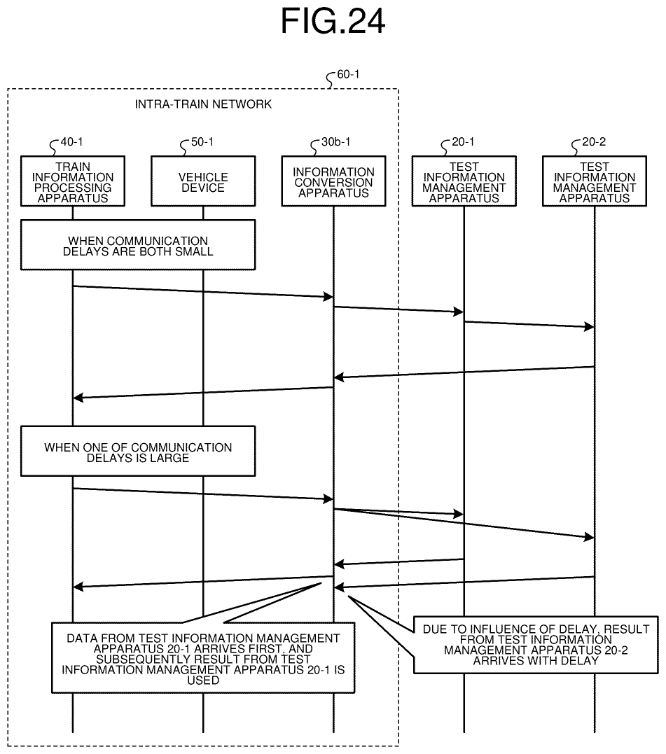

FIG. 24 is a diagram illustrating an example in which the information conversion apparatus 30b-1 according to the third embodiment selects the data from among the pieces of data received from the test information management apparatuses 20-1 and 20-2. FIG. 24 is a diagram for describing which of the pieces of data received from the test information management apparatuses 20-1 and 20-2 is used by the information conversion apparatus 30b-1 based on the communication delays between the information conversion apparatus 30b-1 and the test information management apparatuses 20-1 and 20-2. When the communication delays between the information conversion apparatus 30b-1 and the test information management apparatuses 20-1 and 20-2 are both small, the problem does not arise because it makes no difference whether the information conversion apparatus 30b-1 uses the data received from the test information management apparatus 20-1 or the data received from the test information management apparatus 20-2. On the other hand, when one of the communication delays is large, that is, when the communication delay between the information conversion apparatus 30b-1 and the test information management apparatus 20-1 is small and the communication delay between the information conversion apparatus 30b-1 and the test information management apparatus 20-2 is large, the information conversion apparatus 30b-1 first receives the data from the test information management apparatus 20-1 and receives the data from the test information management apparatus 20-2 with a delay. In such a case, the information conversion apparatus 30b-1 determines that the communication delay is large in the network through which the data from the test information management apparatus 20-2 passes, and performs processing to use the data from the test information management apparatus 20-1. That is, the information conversion apparatuses 30b-1 and 30b-2 manage the respective communication delays in transmission and reception of the data between the information conversion apparatus 30b-1 and the plurality of test information management apparatuses 20 and between the information conversion apparatus 30b-2 and the plurality of test information management apparatuses 20, and each use the data received from one of the test information management apparatuses 20 with a smaller communication delay.

Note that, in the configuration illustrated in FIG. 22, the use data determination unit 37 of the information conversion apparatus 30b notifies the data distribution management unit 34 of a result of determining the data to be used, but the present disclosure is not limited thereto. The use data determination unit 37 may notify at least one of the data management unit 32 and the protocol conversion unit 33 of the result of determining the data to be used. In this case, the information conversion apparatus 30b can omit the operations of the data management unit 32 and the protocol conversion unit 33 with respect to the data to be finally discarded, and thus, a processing load can be reduced.

Additionally, the description has been made that the information conversion apparatus 30b has the configuration in which the communication delay management unit 36 and the use data determination unit 37 are added to the information conversion apparatus 30a of the second embodiment illustrated in FIG. 19, but the present disclosure is not limited thereto. The information conversion apparatus 30b may have a configuration in which the communication delay management unit 36 and the use data determination unit 37 are added to the information conversion apparatus 30 of the first embodiment illustrated in FIG. 7.

As described above in the third embodiment, even when the provision of the plurality of test information management apparatuses 20 causes the increase in the communication delay between a certain test information management apparatus 20 and the information conversion apparatus 30b, the test information management system 10 can continuously perform the real-time operations via the extra-train network 70 since the information conversion apparatus 30b can use the data having a smaller communication delay received from the test information management apparatus 20 other than the certain test information management apparatus 20. The test information management system 10 is also applicable to a case where the test information management apparatus 20 is operated as a redundant system.

The hardware configuration of the information conversion apparatus 30b is similar to the hardware configuration of the information conversion apparatus 30 of the first embodiment. In the information conversion apparatus 30b, the communication unit 31 is a communicator capable of performing wireless communication with the test information management apparatus 20 in the extra-train network 70 and capable of performing wired communication with the train information processing apparatus 40 and the vehicle device 50 in the intra-train network 60. The data management unit 32, the protocol conversion unit 33, the data distribution management unit 34, the difference extraction unit 35, the communication delay management unit 36, and the use data determination unit 37 are implemented by processing circuitry. The processing circuitry may include a memory that stores a program and a processor that executes the program stored in the memory or may include dedicated hardware. The processing circuitry is also referred to as a control circuit.

### Fourth Embodiment

In the first to third embodiments, it has been assumed that the test information management apparatuses 20 are disposed in the extra-train network 70. In a fourth embodiment, a description will be given of a case where the test information management apparatuses 20 are disposed in a train.

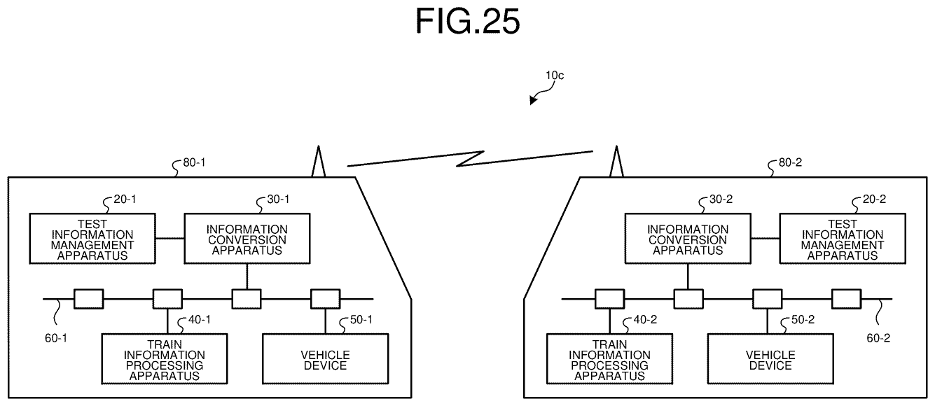

FIG. 25 is a diagram illustrating an exemplary configuration of a test information management system 100 according to the fourth embodiment. In the test information management system 10c, the test information management apparatus 20-1 is disposed in the train 80-1 and connected to the information conversion apparatus 30-1. The test information management apparatus 20-2 is disposed in the train 80-2 and connected to the information conversion apparatus 30-2. Additionally, for the test information management system 10c, a network configuration is assumed in which the train 80-1 and the train 80-2 directly communicate with each other by wireless communication or communicate with each other via an infrastructure. In the case of such a network configuration, with respect to a case where a communication delay is a problem in data communication between the trains 80-1 and 80-2 connected by wireless communication, each apparatus and each device of the test information management system 10c perform processing similar to those in the first embodiment, thereby enabling a continuation of the operations as the test information management system 10c.

A description will now be given of a flow of data in the test information management system 10c according to the fourth embodiment. For example, it is assumed that the data such as the pieces of control command information is transmitted from the train information processing apparatus 40-1 to the vehicle device 50-2. In this case, when the train information processing apparatus 40-1 transmits the data, the information conversion apparatus 30-1 receives the data via the intra-train network 60-1. The information conversion apparatus 30-1 converts the communication protocol of the received data and transmits the data whose communication protocol has been converted to the test information management apparatus 20-1. The test information management apparatus 20-1 distributes the received data to the information conversion apparatus 30-2. At this time, the test information management apparatus 20-1 may directly distribute the received data to the information conversion apparatus 30-2 or may indirectly distribute the received data to the information conversion apparatus 30-2 via the information conversion apparatus 30-1. The information conversion apparatus 30-2 distributes, to the vehicle device 50-2 via the intra-train network 60-2, the data received directly or indirectly from the test information management apparatus 20-1. The operation of each apparatus when the test information management apparatus 20-1 directly distributes the received data to the information conversion apparatus 30-2 is similar to the operation of each apparatus in the first embodiment.

Next, it is assumed that the pieces of device information are transmitted from the vehicle device 50-2 to the train information processing apparatus 40-1 as a response to the data such as the pieces of control command information. In this case, when the vehicle device 50-2 transmits the data, the information conversion apparatus 30-2 receives the data via the intra-train network 60-2. The information conversion apparatus 30-2 converts the communication protocol of the received data and transmits the data whose communication protocol has been converted to the test information management apparatus 20-2. The test information management apparatus 20-2 distributes the received data to the information conversion apparatus 30-1. At this time, the test information management apparatus 20-2 may directly distribute the received data to the information conversion apparatus 30-1 or may indirectly distribute the received data to the information conversion apparatus 30-1 via the information conversion apparatus 30-2. The information conversion apparatus 30-1 distributes, to the train information processing apparatus 40-1 via the intra-train network 60-1, the data received directly or indirectly from the test information management apparatus 20-2. The operation of each apparatus when the test information management apparatus 20-2 directly distributes the received data to the information conversion apparatus 30-1 is similar to the operation of each apparatus in the first embodiment.

As described above, in the fourth embodiment, the test information management system 10c can obtain the same effects as those of the test information management system 10 of the first embodiment even when the test information management apparatuses 20 are disposed in the trains 80-1 and 80-2. Note that, although the test information management system 10c of the fourth embodiment has been described by taking the first embodiment as an example, the test information management system 10c can also be applied to the second embodiment and the third embodiment.

### Fifth Embodiment

In a fifth embodiment, a description will be given of a case where the test information management apparatus learns the device model.

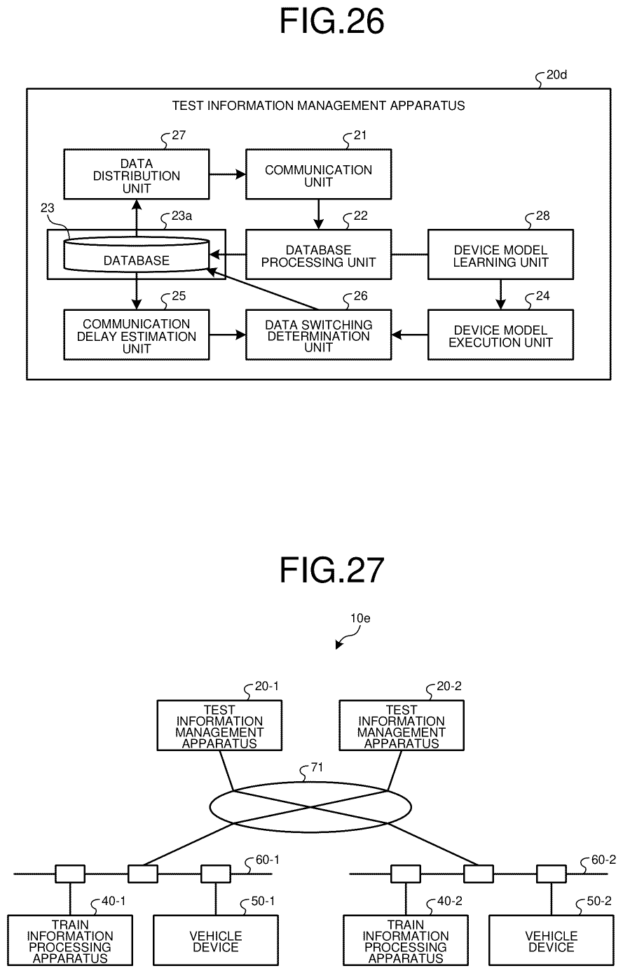

FIG. 26 is a diagram illustrating an exemplary configuration of a test information management apparatus 20d according to the fifth embodiment. The test information management apparatus 20d has a configuration in which a device model learning unit 28 is added to the test information management apparatus 20 of the first embodiment illustrated in FIG. 6. Each time the data is received from the train information processing apparatus 40 and the vehicle device 50, the device model learning unit 28 learns a relationship between input data to the train information processing apparatus 40 and output data from the train information processing apparatus 40, learns a relationship between input data to the vehicle device 50 and output data from the vehicle device 50, learns the device model included in the device model execution unit 24, and automatically updates the device model. Examples of a learning method in the device model learning unit 28 include machine learning, but this is a non-limiting example. The device model learning unit 28 may automatically generate the device model by performing machine learning on a response data from each apparatus when a specific data is updated. In this case, the test information management apparatus 20d stops execution of the device model in the device model execution unit 24 at the start of its operations, and executes the device model in the device model execution unit 24 after the device model learning unit 28 has learned the device model and sufficient learning has been performed in the device model.

Consequently, the test information management apparatus 20d can execute alternative processing using the device model without preparing the device model in advance.

The hardware configuration of the test information management apparatus 20d is similar to that of the test information management apparatus 20 of the first embodiment. In the test information management apparatus 20d, the communication unit 21 is a communicator capable of performing, in the extra-train network 70, wireless communication with the information conversion apparatus 30. The storage unit 23a is a memory. The database processing unit 22, the device model execution unit 24, the communication delay estimation unit 25, the data switching determination unit 26, the data distribution unit 27, and the device model learning unit 28 are implemented by processing circuitry. The processing circuitry may include a memory that stores a program and a processor that executes the program stored in the memory or may include dedicated hardware. The processing circuitry is also referred to as a control circuit.

### Sixth Embodiment

In a sixth embodiment, a description will be given of a case where the test information management system does not include the information conversion apparatus.

FIG. 27 is a diagram illustrating an exemplary configuration of a test information management system 10e according to the sixth embodiment. The test information management system 10e includes the test information management apparatuses 20-1 and 20-2, the train information processing apparatuses 40-1 and 40-2, and the vehicle devices 50-1 and 50-2. In the test information management system 10e, the test information management apparatuses 20, the train information processing apparatuses 40, and the vehicle devices 50 communicate with each other via the dedicated network 71. In this case, the test information management apparatus 20 handles the data whose communication protocol is not converted, but the operations themselves are the same as those in the first embodiment and the like. In the test information management system 10e, the test information management apparatus 20 monitors the data in the dedicated network 71, receives the data, and registers the received data in the database 23. Additionally, the test information management apparatus 20 executes the device model using the data whose communication protocol is not converted, uses the execution result as the data in accordance with the communication delays, and distributes the data to the train information processing apparatus 40, the vehicle device 50, and the like.

As described above, the test information management system 10e can obtain the same effects as those of the first embodiment even when the dedicated network 71 is used.

The configurations described in the above embodiments are illustrative only and may be combined with the other known techniques, the embodiments may be combined with each other, and part of each of the configurations may be omitted or modified without departing from the gist.

### REFERENCE SIGNS LIST

10, 10c, 10e test information management system; 20, 20-1, 20-2, 20d test information management apparatus; 21, 31, 41 communication unit, 22 database processing unit; 23 database; 23a storage unit; 24 device model execution unit; 25 communication delay estimation unit, 26 data switching determination unit; 27 data distribution unit, 28 device model learning unit, 30, 30-1, 30-2, 308, 30a-1, 30a-2, 30b, 30b-1 information conversion apparatus; 32, 44 data management unit; 33 protocol conversion unit; 34 data distribution management unit; 35 difference extraction unit; 36 communication delay management unit; 37 use data determination unit; 40, 40-1, 40-2, 400-1, 400-2 train information processing apparatus; 42 control command information generation unit; 43 management information generation unit, 50-1, 50-2, 500-1, 500-2 vehicle device, 60-1, 60-2, 600, 600-1, 600-2 intra-train network; 70, 700 extra-train network; 71 dedicated network; 80-1, 80-2, 800 train; 100 train control system; 501-1, 501-3 propulsion control device; 502-1, 502-2, 502-3 door control device; 503-1, 503-2, 503-3 brake control device.

1. A test information management system comprising:
train information processing circuitry to transmit and receive, in a first intra-train network, data to and from a vehicle device in a second intra-train network and to manage an operation of the vehicle device; and
a test information management circuit including device model execution circuitry capable of executing processing identical to processing executed by the train information processing circuitry and the vehicle device, and to perform control to distribute data transmitted from a transmission source of the data or data obtained by the device model execution circuitry to a transmission destination of the data, on a basis of a communication state between the train information processing circuitry and the vehicle device.

2. The test information management system according to claim 1, wherein
the test information management circuit manages, as the communication state, a communication delay in transmission and reception of the data between the test information management circuit and the first intra-train network and a communication delay in transmission and reception of the data between the test information management circuit and the second intra-train network, and distributes the data obtained by the device model execution circuitry to the transmission destination of the data when each of the communication delays exceeds a predetermined delay threshold.

3. The test information management system according to claim 1, wherein
the test information management circuit registers, in a database, the data transmitted from the transmission source of the data or the data obtained by the device model execution circuitry, and distributes, to a request source of a data subscription request for the data, the data that is a target of the data subscription request and is registered in the database.

4. The test information management system according to claim 1, wherein
the test information management circuit learns a device model included in the device model execution circuitry.

5. The test information management system according to claim 1, wherein
the test information management circuit is disposed in an extra-train network different from the first intra-train network and the second intra-train network, and
the test information management circuit further comprises:
first information conversion circuitry to convert a communication protocol of the data in the first intra-train network when the data is transmitted and received between the train information processing circuitry and the test information management circuit; and
second information conversion circuitry to convert a communication protocol of the data in the second intra-train network when the data is transmitted and received between the test information management circuit and the vehicle device.

6. The test information management system according to claim 5, wherein
the test information management circuit includes a plurality of test information circuits in the extra-train network, and
the first information conversion circuitry and the second information conversion circuitry manage respective communication delays in transmission and reception of the data between the first information conversion circuitry and the plurality of the test information management circuits and between the second information conversion apparatus and the plurality of the test information management circuits, and each use the data received from one of the plurality of the test information management circuits with a smaller communication delay.

7. The test information management system according to claim 5, wherein
the first information conversion circuitry and the second information conversion circuitry each extract, from latest data, difference data between the latest data and previously transmitted data, convert a communication protocol of the difference data, and transmit the difference data whose communication protocol has been converted, and also convert the communication protocol of the difference data received, and combine the difference data whose communication protocol has been converted with previously received data to restore the latest data.

8. A test information management apparatus comprising:
communication circuitry to transmit and receive data whose transmission source or transmission destination is train information processing circuitry and a vehicle device, the train information processing apparatus being an apparatus to transmit and receive, in a first intra-train network, the data to and from the vehicle device in a second intra-train network and to manage an operation of the vehicle device;
storage circuitry storing a database to allow the data to be registered;
device model execution circuitry capable of executing processing identical to processing executed by the train information processing circuitry and the vehicle device;
database processing circuitry to register in the database the data received by the communication circuitry and to output the data to the device model execution circuitry;
communication delay estimation circuitry to monitor an update cycle of the data registered in the database and to estimate communication delays in communication between the test information management apparatus and the first intra-train network and communication between the test information management circuitry and the second intra-train network;
data switching determination circuitry to perform, on a basis of the communication delays estimated by the communication delay estimation circuitry, control to register, in the database, data obtained by the device model execution circuitry; and
data distribution circuitry to perform, when the data is updated in the database, control to distribute, via the communication circuitry, the data updated in the database to the first intra-train network or the second intra-train network.

9. The test information management apparatus according to claim 8, wherein
the data switching determination circuitry registers the data obtained by the device model execution circuitry in the database when each of the communication delays estimated by the communication delay estimation circuitry exceeds a predetermined delay threshold.

10. The test information management apparatus according to claim 8, wherein
data transmitted from the transmission source of the data or data obtained by the device model execution circuitry is registered as the data in the database, and
the data distribution circuitry performs control to distribute, to a request source of a data subscription request for the data, the data via the communication circuitry, the data being a target of the data subscription request and registered in the database.

11. The test information management apparatus according to claim 8, comprising
device model learning circuitry to learn a device model included in the device model execution circuitry.

12. An information conversion apparatus comprising:
communication circuitry to transmit and receive data to and from each of train information processing circuitry, a vehicle device, and a test information management circuit, the train information processing circuitry being circuitry to manage an operation of the vehicle device, the test information management circuit being a circuit to control transmission and reception of the data to and from the information conversion apparatus on a basis of a communication delay between the test information management circuit and the information conversion apparatus;
data management circuitry to manage a transmission destination of the data received by the communication circuitry;
protocol conversion circuitry to perform first protocol conversion to convert a communication protocol of the data when a transmission source of the data is in a same first intra-train network as the information conversion apparatus and a transmission destination of the data is in a second intra-train network different from the first intra-train network, and to perform second protocol conversion opposite to the first protocol conversion on the data when the transmission source of the data is in the second intra-train network and the transmission destination of the data is in the first intra-train network; and
data distribution management circuitry to perform control to distribute, to the transmission destination via the communication circuitry, the data whose communication protocol has been converted by the protocol conversion circuitry.

13. The information conversion apparatus according to claim 12, wherein
the test information management circuit is disposed in an extra-train network different from the first intra-train network and the second intra-train network, and the train information processing circuitry and the vehicle device, which are in intra-train networks different from each other, transmit and receive the data to and from each other via the test information management circuit, and
the protocol conversion circuitry performs the first protocol conversion on the data to be transmitted to the test information management circuit and performs the second protocol conversion on the data received from the test information management circuit.

14. The information conversion apparatus according to claim 13, wherein
the test information management circuit includes a plurality of test information management circuits in the extra-train network, and
the information conversion apparatus further comprises:
communication delay management circuitry to measure and manage communication delays between the information conversion apparatus and the plurality of the test information management circuits; and
use data determination circuitry to use the data received from one of the plurality of the test information management circuits with a smaller communication delay.

15. The information conversion apparatus according to claim 13, further comprising
difference extraction circuitry to extract, from first latest data to be transmitted to the test information management circuit, first difference data between the first latest data and first previously transmitted data, wherein
the protocol conversion circuitry performs the first protocol conversion on the first difference data extracted by the difference extraction circuitry,
the data distribution management circuitry performs control to distribute, via the communication circuitry, the first difference data subjected to the first protocol conversion in the protocol conversion circuitry, and
when the communication circuitry receives, from the test information management circuit, second difference data extracted by another information conversion apparatus,
the protocol conversion circuitry performs the second protocol conversion on the second difference data, and
the data distribution management circuitry performs control to combine the second difference data subjected to the second protocol conversion in the protocol conversion circuitry, with second previously received data to restore second latest data, and to distribute the second latest data via the communication circuitry.

16. A test information management method for a test information management system, the method comprising:
transmitting and receiving, in a first intra-train network, data to and from a vehicle device in a second intra-train network and managing an operation of the vehicle device; and
performing control to distribute data transmitted from a transmission source of the data or data obtained by device model execution circuitry of a test information management circuit to a transmission destination of the data, on a basis of a communication state between a train information processing circuitry and the vehicle device, the device model execution circuitry being capable of executing processing identical to processing executed by the train information processing circuitry and the vehicle device.

17. The test information management method according to claim 16, wherein
performing the control to distribute the data includes managing, as the communication state, a communication delay in transmission and reception of the data between the test information management circuit and the first intra-train network and a communication delay in transmission and reception of the data between the test information management apparatus and the second intra-train network, and distributes the data obtained by the device model execution circuitry to the transmission destination of the data when each of the communication delays exceeds a predetermined delay threshold.

18. The test information management method according to claim 16, wherein
performing the control to distribute the data includes registering, in a database, the data transmitted from the transmission source of the data or the data obtained by the device model execution circuitry, and distributing, to a request source of a data subscription request for the data, the data that is a target of the data subscription request and is registered in the database.

19. The test information management method according to claim 16, wherein
performing the control to distribute the data includes learning a device model included in the device model execution circuitry.

20. The test information management method according to claim 16, wherein
performing the control to distribute the data includes disposing the test information management apparatus is in an extra-train network different from the first intra-train network and the second intra-train network, and
the test information management method further comprises:
converting a communication protocol of the data in the first intra-train network when the data is transmitted and received between the train information processing circuitry and the test information management circuit; and
converting a communication protocol of the data in the second intra-train network when the data is transmitted and received between the test information management circuit and the vehicle device.

21. (canceled)

22. (canceled)
